(19) United States
(12) Patent Application Publication
(10) Pub. No.: US 2018/0283149 A1
(43) Pub. Date: Oct. 4, 2018

(54) METHODS FOR MANAGING FORMATION VOIDAGE REPLACEMENT IN WATERFLOOD PRODUCTION OPERATIONS TO INCREASE OIL RECOVERY

(71) Applicant: BP Corporation North America Inc., Houston, TX (US)

(72) Inventors: Euthimios Vittoratos, Chico, CA (US); Ahouyuan Zhu, Jiangsu (CN); Christopher C. West, Anchorage, AK (US); Giovanna Boccardo, Houston, TX (US)

(73) Assignee: BP Corporation North America Inc., Houston, TX (US)

(21) Appl. No.: 15/524,995

(22) PCT Filed: Nov. 6, 2015
(86) PCT No.: PCT/US2015/059375

§ 371 Date: May 5, 2017

Related U.S. Application Data
(60) Provisional application No. 62/076,728, filed on Nov. 7, 2014.

(51) Int. Cl. E21B 43/20; E21B 41/00; E21B 47/06; E21B 49/00; E21B 49/08; E21B 43/30; G01V 99/00

(52) U.S. Cl. CPC E21B 43/20; E21B 41/0092; E21B 47/06; E21B 2049/085; E21B 49/087; E21B 43/30; G01V 99/005; E21B 49/00

(57) ABSTRACT

A method for waterflooding of a reservoir in a subterranean formation includes (a) appraising the reservoir to obtain a plurality of physical properties relating to the formation and the oil in the reservoir. The plurality of physical properties include a reservoir pressure and a Bubblepoint pressure of the oil in the reservoir. The method also includes (b) determining that the Bubblepoint pressure is greater than 60% of the reservoir pressure. In addition, the method includes (c) waterflooding the reservoir at a voidage replacement ratio (VRR) less than 1.0 based on the determination in (b).

### CROSS-REFERENCE TO RELATED APPLICATIONS

This application claims benefit of U.S. provisional patent application Ser. No. 62/076,728 filed Nov. 7, 2014, and entitled “Methods for Optimizing Waterflood Voidage Management to Increase Oil Recovery with Minimal Incremental Cost,” which is hereby incorporated herein by reference in its entirety.

### STATEMENT REGARDING FEDERALLY SPONSORED RESEARCH OR DEVELOPMENT

Not applicable.

### BACKGROUND

The disclosure relates generally to waterflooding operations for recovering hydrocarbons from subterranean reservoirs. More particularly, the disclosure relates to methods for managing formation voidage replacement in waterflooding operations to enhance the recovery of subterranean hydrocarbons.

In many light oil (32°-40° API gravity) reservoirs and some medium oil (20°-32° API gravity) reservoirs, the original oil-in-place (OIP) may be recovered in three stages. In an initial stage, usually termed “primary” production, the intrinsic reservoir pressure is sufficient to drive the oil from the subterranean reservoir into the production. Usually, only a fraction of the original OIP is produced by this method—roughly up to about 20% of the original OIP is produced. The next stage of production, usually termed “secondary” production, relies on alternative production techniques (other than the intrinsic reservoir pressure) to recovery more of the original OIP. Waterflooding is one type of secondary recovery technique that employs a plurality of wells drilled into the reservoir. The wells may include a plurality of horizontally-spaced vertically oriented wells drilled into the reservoir and/or a plurality of horizontally-spaced horizontally oriented wells drilled into the reservoir. Water is injected under pressure into the reservoir through one or more of the wells, each referred to as an “injection” well. The water increases the reservoir pressure, and as the water moves through the formation, it displaces oil from the pore spaces. The displaced oil is pushed or swept through the formation and into one or more of the other wells, each referred to as a “production” well. The hydrocarbons and any water collected in the production wells are produced to the surface via natural flow or artificial lift (i.e., with or without artificial lift). Waterflooding can be used to recover additional oil—roughly up to an additional 30% of the original OIP. After this point, the cost of continuing a waterflood often becomes uneconomical relative to the value of the oil produced. Hence, as much as 50% of the original OIP can remain in the reservoir after a reservoir has been extensively waterflooded. The third stage of production, usually terms “tertiary” production, may utilize one or more other known enhanced oil recovery methods such as polymer flooding or CO₂ flooding.

Secondary recovery techniques employing displacement fluids, such as waterflooding, are usually inefficient in subterranean formations where the mobility of the in-situ oil being recovered is significantly less than the mobility of the drive fluid used to displace the oil. This is generally the case because the relatively high mobility of the water relative to the mobility of the oil results in the water moving through the formation along preferential paths or “fingers” around the in-situ oil, as opposed to the water pushing and displacing the in-situ oil as it moves through the formation. For waterflooding, the displacement of oil typically becomes inefficient for oils having viscosities greater than about 10.0 cp. For example, when waterflooding is used to displace viscous oils and heavy oils in a subterranean formation, the process is usually very inefficient because the mobility of the oil is significantly less than the mobility of the water. In general, oil having an API gravity below 22.3° API is traditionally considered “heavy” oil, and oil having an API gravity of 30° API or less is generally considered “viscous” oil.

For the foregoing reasons, conventional approaches to enhance the efficiency of waterflooding operations has focused on (a) making the water more viscous through use of particulates, polymers, or other chemical agents (i.e., decrease the mobility of the injected water), or (b) using another drive fluid that will not “finger” as easily through the formation around the oil. For modestly viscous oils having viscosities of about 20.0 to 100.0 centipoise (cp), water-soluble polymers such as polyacrylamides and xanthan gum have been used to increase the viscosity of the water injected in waterfloods. In such processes, the polymer is typically dissolved in the water to increase the viscosity of the water.

When employing waterflooding as a secondary recovery technique, the conventional approach has been to fully replace the volume of fluids produced from the reservoir with the volume of water injected (i.e., maintain the Voidage Replacement Ratio or VRR equal to 1.0), both instantaneously (i.e., at any given time during the waterflood) and cumulatively (over the total timespan of the waterflood) as described in U.S. Pat. No. 8,356,665, which is hereby incorporated herein by reference. Maintaining an even VRR (i.e., a VRR=1.0) is so ingrained in industry practice today, that Canadian producers must obtain permission from government regulators to deviate the VRR from a value of 1.0.

### BRIEF SUMMARY OF THE DISCLOSURE

Embodiments of methods for waterflooding of a reservoir in a subterranean formation to produce oil from the reservoir are disclosed herein. In one embodiment, the method comprises (a) appraising the reservoir to obtain a plurality of physical properties relating to the formation and the oil in the reservoir. The plurality of physical properties include a reservoir pressure and a Bubblepoint pressure of the oil in the reservoir. In addition, the method comprises (b) determining that the Bubblepoint pressure is greater than 60% of the reservoir pressure. Further, the method comprises (c) waterflooding the reservoir at a voidage replacement ratio (VRR) less than 1.0 based on the determination in (b).

Another embodiment for waterflooding of a reservoir in a subterranean formation to produce oil from the reservoir comprises (a) appraising the reservoir to obtain a plurality of physical properties relating to the formation and the oil in the reservoir. In addition, the method comprises (b) modeling the reservoir based on the physical properties obtained in (a). Further, the method comprises (c) performing a first waterflood simulation of the reservoir in the model at a first voidage replacement ratio (VRR) equal to 1.0. Still further, the method comprises (d) performing a second waterflood simulation of the reservoir in the model at a second voidage replacement ratio (VRR) less than 1.0. The method also comprises (e) determining at least one of the following: that the second waterflood simulation yields a greater cumulative oil recovery from the reservoir than the first waterflood simulation over a period of time; and that the second waterflood simulation yields a greater recovery factor (RF) than the first waterflood simulation over a range of pore volumes injected. Moreover, the method comprises (f) waterflooding the reservoir at a voidage replacement ratio (VRR) less than 1.0 based on the determination in (e).

Another embodiment for waterflooding of a reservoir in a subterranean formation to produce oil from the reservoir comprises (a) waterflooding the reservoir with an injection well and a production well. In addition, the method comprises (b) operating the waterflood at a first voidage replacement ratio (VRR) less than 1.0 for an initial period of time. Further, the method comprises (c) operating the water flood at a second VRR equal to 1.0 after the initial period of time.

Embodiments described herein comprise a combination of features and advantages intended to address various shortcomings associated with certain prior devices, systems, and methods. The foregoing has outlined rather broadly the features and technical advantages of the invention in order that the detailed description of the invention that follows may be better understood. The various characteristics described above, as well as other features, will be readily apparent to those skilled in the art upon reading the following detailed description, and by referring to the accompanying drawings. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is an embodiment of a method in accordance with principles described herein for defining the operational parameters of a waterflood production operation for a specific reservoir at VRR<1.0 (for a period of time);

FIG. 2 is a graphical illustration of a permeability cumulative distribution of the permeabilities of all the cells in a geological reservoir model of an exemplary reservoir;

FIG. 3 is a graphical illustration of the relative permeability of the gas (krg) versus the liquid saturation (Sl) of an exemplary reservoir;

FIG. 4 is a graphical illustration of the water fractional flow (fw) versus the gas saturation (Sg) of an exemplary reservoir;

FIG. 5 is a graphical illustration of the recovery factor (RF) versus pore volume injected for a waterflood simulation of an exemplary reservoir at VRR=1.0 and VRR<1.0;

FIG. 6 is a graphical illustration of the recovery factor (RF) versus time for a waterflood simulation of an exemplary reservoir at VRR=1.0 and VRR<1.0;

FIG. 7 is a graphical illustration of the percentages of recovered oil attributable to VRR=1.0 recovery mechanisms and VRR<1.0 recovery mechanisms;

FIG. 8 is a graphical illustration of Sw-Swi versus So-Soi for each cell in the numerical simulation model of a waterflood of an exemplary reservoir at VRR<1.0;

FIG. 9 is an embodiment of a method in accordance with the principles described herein for producing a reservoir via waterflood using the operational parameters output from the method of FIG. 1;

FIG. 10 is a graphical illustration of the water fractional flow (fw) versus the gas saturation (Sg) for numerical simulations of a reservoir with a mobility ratio of 30.0 and 10.0;

FIG. 11 is a graphical illustration of the water oil ratio (WOR) versus the cumulative oil produced and cumulative oil produced versus the cumulative water injected for a viscous 1D VRR<1.0 simulation with a critical gas saturation (Sgc) of 5%;;

FIG. 12 is a graphical illustration of the water oil ratio (WOR) versus the cumulative oil produced and the cumulative oil produced versus cumulative water injected for a viscous oil 1D VRR<1.0 simulation with a critical gas saturation (Sgc) of 2%;

FIG. 13 is an influence diagram for a 1D VRR simulation;

FIG. 14 is a graphical illustration of type pattern model (TPM) simulations and the associated permeability distribution and the well configurations;

FIG. 15 is a graphical illustration of a VRR history for a VRR=1 simulation and a VRR<1.0 simulation for the viscous and heavy oil models;

FIG. 16 is a graphical illustration of the cumulative oil produced versus time for VRR=1 and VRR<1.0 simulations for the viscous and heavy oil models;

FIG. 17 is a graphical illustration of the cumulative oil produced versus the cumulative water injected (equivalent to Pore Volume Injected) for a VRR=1 and a VRR<1.0 simulation for viscous and heavy oil models;

FIG. 18 is a graphical illustration comparing the heterogeneity of the viscous oil type pattern model (TPM) and the heavy oil type pattern model (TPM) in the horizontal plane;

FIG. 19 is a graphical illustration comparing the heterogeneity of the viscous oil type pattern model (TPM) and the heavy oil type pattern model (TPM) in the vertical plane;

FIG. 20 is a graphical illustration of the permeability cumulative distribution of all the cells in the viscous oil and heavy oil type pattern models (TPMs);

FIG. 21 is a graphical illustration of the permeability cumulative distribution of all the cells in the viscous oil and heavy oil type pattern models (TPMs);

FIG. 22 is a graphical illustration of (Sw-Swi)-(So-Soi) for every cell in the simulation models;

FIG. 23 is a graphical illustration of VRR<1/Cul-de-sac effects for the VRR=1 simulation in the viscous and heavy oil type pattern models (TPMs);

FIG. 24 is a graphical illustration of VRR<1/Cul-de-sac effects for the VRR<1 simulations in the viscous oil TPMs and heavy oil type pattern models (TPMs);

FIG. 25 is a graphical illustration and calculation of the oil displacement volume from the Cul-de-sac zone and VRR<1.0 zone of the heavy oil type pattern model (TPM) simulation at VRR=0.6 and the percentage in total oil recovery from the Cul-de-sac zone and VRR<1.0 zone of the heavy oil type pattern model (TPM) simulation at VRR=0.6;

FIG. 26 is a graphical illustration of pure Cul-de-sac cells in the heavy oil type pattern model (TPM);

FIG. 27 is a graphical illustration of a 3D view of pure Cul-de-sac cells in heavy oil type pattern model (TPM);

FIG. 28 is a graphical illustration of the gas saturation (Sg) in the small Cul-de-sac zone in the viscous oil type pattern model (TPM);

FIG. 29 is a graphical illustration of cumulative oil production versus time for a “big can” VRR<1.0 experiment for a heavy oil;

FIG. 30 is a schematic illustration of the phase behavior of emulsion flow in heavy oil waterflooding;

FIG. 31 is a schematic illustration of the mechanism of the proposed emulsion flow modified black oil model for heavy oil waterflooding;

FIG. 32 is a graphical illustration of the improved water cut match using the proposed emulsion flow modified black oil model for viscous oil water flooding big can experiment (the top is the match using the traditional black oil formulation and the bottom is the match using the modified formulation that considers emulsion formation);

FIG. 33 is a graphical illustration of the improved cumulative oil recovery match using the proposed emulsion flow modified black oil model for viscous oil water flooding big can experiment (the top is the match using the conventional black oil formulation and the bottom is the match using the modified formulation that considers emulsion formation);

FIG. 34 is a graphical illustration of oil recovery versus time for viscous oil VRR<1.0 simulation as compared to VRR=1 simulation;

FIG. 35 is a graphical illustration of the VRR versus time for the viscous oil VRR<1.0 process of FIG. 34;

FIG. 36 is a graphical illustration of oil recovery versus time for the viscous oil VRR<1.0 simulation of FIG. 34; and

FIG. 37 is a schematic illustration of a computing system suitable for implementation of methods disclosed herein.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, the recitation “based on” is intended to mean “based at least in part on.” Thus, if X is based on Y, X may be based on Y and any number of other factors or considerations.

Unless expressly defined otherwise herein, terms used herein have their standard well-known meanings in the art. For example, the following terms used herein have their standard meanings in the art as defined below for purposes of clarity:

“American Petroleum Institute gravity,” or API gravity, is a measure of how heavy or light a petroleum liquid is relative to water.

“Bubblepoint pressure” means the pressure at which gas in solution, or dissolved, in a liquid (e.g., gas dissolved in oil) begins to come out of solution and form bubbles. In general, oil in a reservoir includes some gas (e.g., natural gas) in solution. The Bubblepoint pressure is the pressure at which the gas begins to come out of solution and form bubbles or “free gas.”

“Expected Ultimate Recovery” (EUR) means the stock tank volume of oil ultimately recovered divided by the stock tank volume of the OIP in the reservoir at a temperature of 60° F. and 1 atmosphere pressure.

“Permeability” of the reservoir (k) is the measurement of the ability of a porous formation to transmit fluids, usually expressed in milliDarcy (mD).

“Absolute permeability” is the measurement of the ability to flow or transmit a fluid through the formation when a single fluid or phase is present in the formation, usually expressed in milliDarcy (mD).

“Effective permeability” is the ability to preferentially flow or transmit a particular fluid through a formation when other immiscible fluids are present in the formation (for example, effective permeability of gas in a gas-water reservoir), usually expressed in milliDarcy (mD).

“Relative permeability” (kr) of a fluid is the ratio of the effective permeability of a particular fluid at a particular saturation to the absolute permeability of that fluid at total saturation.

“Mobility” of a fluid phase in a formation is the ratio of the fluid's effective permeability to its viscosity.

“Mobility ratio” is the ratio of the mobility of the displacing fluid (water in waterflooding) to the mobility of the displaced fluid (oil in waterflooding).

“Oil In Place” (OIP) means the original volume of oil in the reservoir prior to production.

“Gas saturation” (Sg) means the fraction of the porosity in a reservoir (or zone within a reservoir) that is occupied by free gas.

“Critical gas saturation” (Sgc) is the gas saturation at which gas first becomes mobile during a waterflood in a porous material that is initially saturated with oil and/or water.

“Gas-Oil Ratio” (GOR) means the ratio of the volume of gas dissolved in solution (i.e., in the oil) in terms of standard cubic feet at 60° F. and 1 atmosphere pressure (SCF) divided by the stock tank barrels or volume of oil at 60° F. and 1 atmosphere pressure, usually expressed as SCF/BBL or m³ gas/m³ oil. The “Solution Gas-Oil Ratio” is the gas-oil ratio, as defined above, of the oil in the reservoir, and the “Production Gas-Oil Ratio” is the gas-oil ratio, as defined above, of the produced oil.

“Pore volume injected” means the total volume of injectant (e.g., water) injected into the reservoir at reservoir conditions divided by the pore volume of the reservoir at reservoir conditions.

“Recovery Factor” (RF) means the stock tank volume of oil recovered in Barrels (BBL) divided by the stock tank of OIP in barrels (BBL), all at a temperature of 60° F. and pressure of 1 atmosphere (note: RF is the decimal equivalent of the percentage of OIP produced).

“Total Acid Number” (TAN) is a measure of acidity that is determined by the amount of potassium hydroxide in milligrams that is needed to neutralize the acids in one gram of oil (mg KOH per gram of oil). TAN is determined according to the ASTM D644 Standard Test Method for Acid Number of Petroleum Products by Potentiometric Titration.

“True stratigraphic thickness” (TST) means thickness of a reservoir bed or rock body after correcting for the dip of the bed or body and the deviation of the well that penetrates it, usually expressed in feet (ft) or meters (m).

“Voidage Replacement Ratio” (VRR) means the volume at reservoir conditions of displacement fluid (water) injected into the hydrocarbon reservoir divided by the volume at reservoir conditions of fluids (oil, gas and water) produced from the reservoir.

“Cumulative VRR” (cum VRR) means the total cumulative volume of injected fluid (water) at reservoir conditions divided by the total cumulative volume of produced fluids (oil, water, and gas) at reservoir conditions.

“Viscosity” (μ) is the measure of the resistance of a fluid to flow, usually expressed as centipoise (cp).

“Volumetric sweep efficiency” (EV) means the percentage (by volume) of the formation rock containing a reservoir that is swept or expected to be swept by the injected or displacing fluid in a waterflood.

“Water/Oil Ratio” (WOR) means the volume of water produced divided by the stock tank volume of oil produced both at 60° F. and 1 atmosphere pressure.

“Water cut” means the volume fraction of water to the total liquid volume produced from a well at 60° F. and 1 atmosphere pressure

As previously described, oil recovery through use of secondary recovery techniques employing displacement fluids, such as waterflooding, is usually inefficient in subterranean formations where the mobility of the in-situ oil is significantly less than the mobility of the drive fluid used to displace the oil because the water has a strong tendency to move through the formation along preferential paths or “fingers” around the in-situ oil (as opposed to the water pushing and displacing the in-situ oil as it moves through the formation). Notwithstanding such inefficiency, waterflooding is still considered an option for recovering viscous and heavy oils. For example, in Western Canada, 5,200 million m³ of heavy oil is estimated to be in place in Alberta and Saskatchewan. However, only a fraction of this heavy oil has been recovered by more than 200 waterflood operations, with a typical recovery of about 24% of the original OIP. Accordingly, even a small improvement in the efficiency of waterflooding reservoirs containing heavy oil could yield a substantially greater amount of recoverable reserves. Conventional approaches to enhance the efficiency of waterfloods has been to either (a) make the water more viscous through use of particulates, polymers, or other chemical agents (i.e., decrease the mobility of the injected water), or (b) to use another drive fluid that will not “finger” as easily through the formation around the oil. Although water-soluble polymers may be used to achieve a favorable displacement of relatively low viscosity oils, usually this approach cannot economically be applied to more viscous or heavy oils because the amount of polymer needed to achieve a favorable mobility ratio is usually cost prohibitive. Further, polymers dissolved in water are often desorbed from the drive water onto surfaces of the formation rock, entrapping it and rendering it ineffective for viscosifying the water. This undesirably results in loss of mobility control, poor oil recovery, and high polymer costs. Other drive fluids (other than water) that employ various chemical, particulate emulsifying agents, or emulsions may enhance oil recovery, but are often expensive and difficult to employ in practical use. Accordingly, conventional approaches employing water viscosifying agents or higher viscosity drive fluids to improve the efficiency of waterfloods have limitations, particularly within the context of viscous and heavy oils.

Although maintaining an even VRR (i.e., a VRR=1.0) in waterfloods is conventional practice, as will be described in more detail below, evidence suggests this paradigm (i.e., maintaining VRR=1.0) may be sub-optimal for waterflooding of some viscous and heavy oils in certain formations, and that operating the waterflood with VRR<1.0 for periods of time offers the potential to enhance the volume of the original OIP recovered during the waterflood. This approach offers the potential to enhance the efficiency, performance, and economics of waterfloods without relying on viscosifying agents or higher viscosity drive fluids. Accordingly, embodiments described herein are directed to methods for assessing reservoirs to determine potential benefits of operating a waterflood at VRR<1.0 (for a period of time) and methods for managing voidage replacement (i.e., VRR) during waterflood operations to enhance oil recovery.

As noted above, evidence suggests that for certain reservoirs, operating waterfloods at VRR<1.0 for periods of time offers the potential to enhance the volume of the original OIP recovered during the waterflood. More specifically, operating waterfloods at VRR<1.0 reduces reservoir pressure, which in turn can enable the release of gas dissolved in the oil (e.g., if the reservoir pressure is reduced to or below the Bubblepoint of the oil in the reservoir) and/or allow gas in the reservoir to expand. As will be described in the Examples below, these consequences can activate additional recovery mechanisms that may not be available at VRR=1.0 such as (a) solution gas drive; (b) foamy oil drive; (c) water and oil emulsifications in response to chemical changes that accompany gas exsolution; and (d) three-phase relative permeability interference. Studies of these additional recovery mechanisms activated by VRR<1.0 were performed via laboratory testing using a two meter long “big can” in AITF (Edmonton, Canada), numerical reservoir simulations using type pattern models (TPM) of shallow marine shoreface and fluvial depositional environments (chosen as representative of relatively low to relatively high reservoir heterogeneity, respectively), simple 1D simulation models, and empirical studies of production histories in various oil fields. Some of these studies are described in the Examples below. It should be appreciated that lowering reservoir pressure by operating at VRR<1.0 may undesirably decrease reservoir energy in some circumstances, and thus, may not be appropriate in all circumstances, and even if instituted, is preferably carefully managed. Accordingly, the results of the studies were analyzed to identify and understand the additional recovery mechanisms, and the scenarios where such recovery mechanisms may be particularly beneficial. Those analyses form the scientific bases underlying the embodiments of methods described herein.

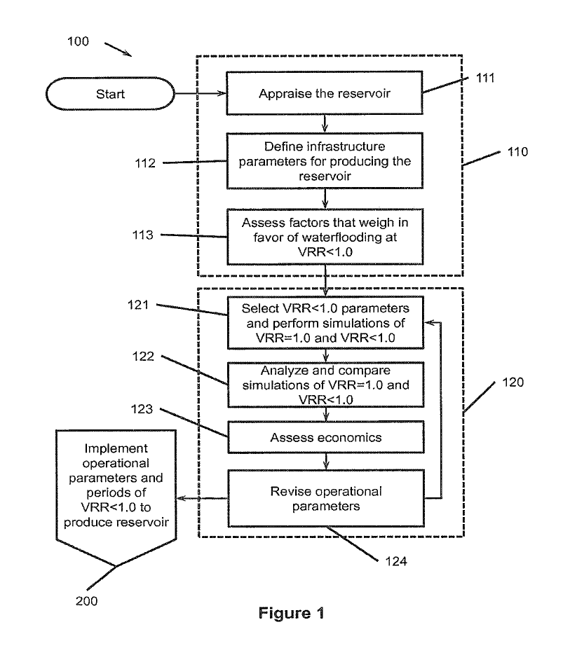

Referring now to FIG. 1, an embodiment of a method 100 in accordance with principles described herein for determining the operational parameters of a waterflood production operation for a specific reservoir is schematically shown. In this embodiment, method 100 includes a first stage 110 for evaluating whether the reservoir is a candidate for waterflooding at VRR<1.0 (for a period of time), and then, if the first stage 110 suggests the reservoir is a candidate for waterflooding at VRR<1.0 (for a period of time), a second stage 120 for optimizing the operational parameters of the waterflood production operation at VRR<1.0 in order to maximize the performance and economics of the waterflood. As will be described in more detail below, the operational parameters for a waterflood production operation at VRR<1.0 include the physical infrastructure for performing the waterflood, referred to herein as the “infrastructure parameters,” and the parameters dictating how the waterflood at VRR<1.0 is performed (e.g., the time at which to initiate VRR<1.0, the period of time to operate at VRR<1.0, and the specific VRR at which to operate during that period of time), referred to herein as “VRR<1.0 parameters.”

The first stage 110 begins in block 111 where the reservoir is appraised. During the appraisal, data relating to the reservoir, and samples of fluids in the reservoir are collected and analyzed to determine and understand a variety of properties relating to the formation rock and fluid(s) in the reservoir including, without limitation, the geology of the formation rock (e.g., structural framework, stratigraphic correlation, depositional environment, petrophysical properties including porosity, water saturation, etc.); the boundaries of the reservoir, water oil contact; the types of fluids in the reservoir (e.g., oil, gas, water, etc.); the composition and physical properties of the fluids within the reservoir (e.g., the chemical composition of the fluids, the viscosity of the fluids, saturation pressures, etc.); and the properties of the reservoir and reservoir-fluid system (e.g., pressure, temperature, permeability, relative permeability of oil-water and gas-liquid, etc.). In general, the appraisal of the reservoir in block 111 is performed according to methods known in the art. Typically, appraisal of the reservoir is performed by seismic acquisition, drilling appraisal wells, collecting and analyzing well logs, collecting and analyzing core samples, collecting and analyzing fluid samples, testing production rates while measuring pressures, etc. It should be appreciated that information from pre-existing appraisal wells and/or production wells in the same field as the reservoir and/or in the particular reservoir being appraised can also be collected and analyzed. In other words, first stage 110, and more generally method 100, is not limited to new fields and reservoirs, and thus, can be applied to reservoirs already being produced as well as reservoirs in fields that have not been produced.

Moving now to block 112, the infrastructure parameters for producing the reservoir via waterflood are selected and defined using the information from the appraisal in block 111 and assuming the waterflood is conducted in a conventional manner with VRR=1.0. In embodiments described herein, the infrastructure parameters include the layout and infrastructure of the systems for producing the reservoir via waterflooding including, without limitation, the number, location, spacing, and layout of the injection well(s) and production well(s) for injecting water into the reservoir and producing fluids from the reservoir, respectively; the water injection system infrastructure and associated capacities (e.g., water injection volume, pressure, and rate capacities); and the production system infrastructure and associated capacities (e.g., type of artificial lift and the requirements to handle the associated production volume, pressure, and rate capacities). In general, the infrastructure parameters are selected and defined as part of a comprehensive reservoir development plan. As is known in the art, a reservoir development plan considers all the information obtained and analyzed in the appraisal of the reservoir (e.g., block 111), evaluates multiple development options, and selects the best option based on the balancing of a variety of factors including, without limitation, the estimated amount of oil to be recovered, economics (e.g., net present value, capital costs, operating costs, etc.), environmental impacts, infrastructure design and construction, well design and construction, completion design, surface facilities, operational flexibility and scalability, and technical, operating and financial risks.

Referring still to FIG. 1, the first stage 110 of method 100 also includes an assessment of a plurality of factors in block 113 to determine whether one or more of those factors weigh in favor of waterflooding at VRR<1.0 (for a period of time). In general, the assessment of the factors includes an analysis of the factors and balancing of the factors to determine whether the reservoir may be particularly suited for producing at VRR<1.0. In other words, the factors are assessed to determine whether operating the waterflood at VRR<1.0 offers potential advantages over a conventional waterflood at VRR=1.0 for the particular reservoir. In this embodiment, the factors can be categorized as relating to (a) fluids in the reservoir, (b) the reservoir geology and size, (c) production information from other wells in the field (if available), (d) the interactions and dynamics between the fluids in the reservoir and the formation rock, and (e) well spacing. Each of these categories of leading indicators will now be discussed in turn.

The factors assessed in block 113 relating to the fluids in the reservoir include the Bubblepoint pressure of the oil in the reservoir relative to the actual reservoir pressure, the API gravity of the oil in the reservoir, and the TAN of the oil in the reservoir. The Bubblepoint pressure of the oil in the reservoir, the actual reservoir pressure, the API gravity of the oil in the reservoir, and the TAN of the oil in the reservoir are determined during appraisal of the reservoir in block 111 using techniques known in the art.

It should be appreciated that the additional recovery mechanisms activated by waterflooding at VRR<1.0 rely on the release of at least some gas from the oil in the reservoir, and thus, necessarily require the reservoir pressure be reduced at least to or below the Bubblepoint pressure of the oil in the reservoir. Waterflooding at VRR<1.0 decreases the reservoir pressure, however, if the Bubblepoint pressure of the oil in the reservoir pressure is too far below the reservoir pressure, it may not be possible or feasible to decrease the reservoir pressure to the Bubblepoint pressure of the oil in the reservoir. Thus, a threshold issue in assessing whether waterflooding at VRR<1.0 is an option is the proximity of the Bubblepoint pressure of the oil in the reservoir to the actual reservoir pressure. In embodiments described herein, if the Bubblepoint pressure of the oil in the reservoir is greater than 60% of the reservoir pressure, waterflooding at VRR<1.0 is an option, whereas if the Bubblepoint pressure of the oil in the reservoir is less than 60% of the reservoir pressure, then waterflooding at VRR<1.0 is generally not considered a viable option.

In general, the lower the API gravity of the oil in the reservoir, the more suitable the reservoir to waterflooding at VRR<1.0 as reservoirs containing heavier, denser oils are typically more susceptible to the undesirable fingering and flow of injected water along preferential paths. Consequently, such reservoirs are more likely to respond favorably to the additional recovery mechanisms triggered by VRR<1.0. In embodiments described herein, the oil in the reservoir preferably has an API gravity less than 27.0, and more preferably less than 22.0. In other words, an oil API gravity less than 27.0 weighs in favor of waterflooding at VRR<1.0, and an oil API gravity less than 22.0 weighs more strongly in favor of waterflooding at VRR<1.0.

In general, the more acidic the oil in the reservoir, the more suitable the reservoir to waterflooding at VRR<1.0 as the more acidic the oil, the more likely the oil is to generate chemical species, in the presence of water and gas release from the oil, that enhance the mobility of the oil in the reservoir. In embodiments described herein, the TAN of the oil in the reservoir is preferably greater than 1.0 mg KOH per gram of oil. In other words, an oil TAN greater than 1.0 mg KOH per gram of oil weighs in favor of waterflooding at VRR<1.0.

The factors assessed in block 113 relating to the reservoir geology and size include the heterogeneity of the formation rock containing the reservoir and the maximum true stratigraphic thickness (TST) of the reservoir. In embodiments described herein, the heterogeneity of the formation is characterized by the permeability cumulative distribution plot of the formation rock containing the reservoir and the depositional environment of the reservoir (e.g., the type of the formation rock containing the reservoir). The permeability cumulative distribution plot of the formation rock, the depositional environment of the reservoir, and the true stratigraphic thickness (TST) (e.g., the maximum true stratigraphic thickness) of the reservoir are determined using techniques known in the art. For example, the depositional environment of the reservoir and the true stratigraphic thickness (TST) of the reservoir are typically determined during appraisal of the reservoir in block 111, and the permeability cumulative distribution plot of the formation rock is typically generated with a model of the reservoir, often referred to as the “geological reservoir model,” based on the data obtained during the appraisal of the reservoir in block 111.

In general, the greater the heterogeneity of the formation rock containing the reservoir, the more susceptible the reservoir is to the undesirable fingering and flow of injected water along preferential paths. Consequently, the more heterogeneous the formation rock, the more likely the reservoir is to respond favorably to the additional recovery mechanisms triggered by VRR<1.0. As noted above, in embodiments described herein, the heterogeneity of the formation is characterized by the permeability cumulative distribution of the formation rock containing the reservoir and the type of the formation rock containing the reservoir.

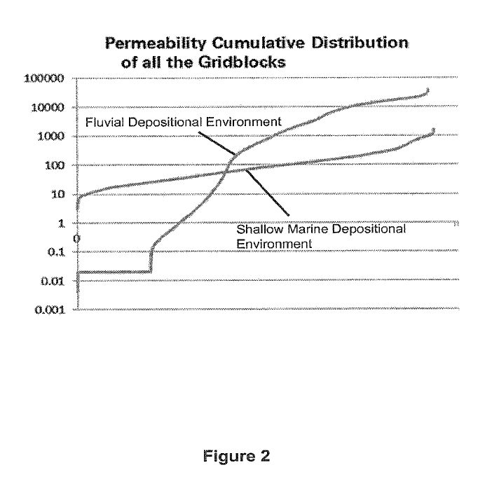

Referring briefly to FIG. 2, the permeability cumulative distribution of an exemplary reservoir comprising a shallow marine depositional environment and an exemplary reservoir comprising a fluvial depositional environment are shown on a single graph. In general, a permeability cumulative distribution curve illustrates the distribution or spectrum of the permeabilities of all the cells or gridblocks in the geological reservoir model prepared during the appraisal of the reservoir in block 111. The Y-axis in a permeability cumulative distribution curve is the permeability of the each gridblock in logarithmic scale and organized in ascending order and the X-axis of the permeability cumulative distribution curve is the correspondent number of gridblocks having each permeability so that all of the gridblocks, that are considered pay zone, are represented.

In general, the greater the span of the permeability cumulative distribution curve relative to the Y-axis, the greater the distribution of permeabilities across the reservoir, which in turns indicates a greater heterogeneity in the formation containing the reservoir. For example, in FIG. 2, the distribution of permeabilities in the reservoir comprising a shallow marine depositional environment spans between two and three log scale cycles on the Y-axis (from about 6 to about 2,000), whereas the distribution of permeabilities in the reservoir comprising a fluvial depositional environment spans between five and six log scale cycles on the Y-axis (from about 0.03 to about 50,000). In embodiments described herein, the permeability cumulative distribution graph of the formation rock containing the reservoir preferably includes at least three cycles in the log scale, and more preferably at least four cycles in the log scale. In other words, a permeability cumulative distribution curve of a reservoir spanning at least three cycles in the log scale weighs in favor of waterflooding the reservoir at VRR<1.0, and a permeability cumulative distribution curve spanning at least four cycles in the log scale weighs more strongly in favor of waterflooding the reservoir at VRR<1.0. Although the permeability cumulative distribution is one factor used in embodiments described herein to assess the heterogeneity of the formation rock, in other embodiments, other plots known in the art, such as the Dyestra-Parsons or Lorentz plots, can be used to assess the heterogeneity of the formation rock.

As described above, the greater the heterogeneity of the formation rock containing the reservoir, the more susceptible the reservoir is to the undesirable fingering and/or flow of injected water along preferential paths. Accordingly, the more heterogeneous the specific type of rock in the formation containing the reservoir, the greater the potential benefits of waterflooding at VRR<1.0. Thus, in embodiments described herein, the formation rock containing the reservoir preferably has a moderate to high degree of heterogeneity. Such types of formation rock include fluvial, deltaic, turbidites, carbonates, highly faulted, and highly fractured. In other words, a formation rock type comprising fluvial, deltaic, turbidites, carbonates, highly faulted, and highly fractured weighs in favor of waterflooding at VRR<1.0. These types of formation rock are known in the art and are defined, for example, in the Dictionary of Geological Terms, 3^{rd} Edition, The America Geological Institute, Robert L. Bates and Julia A. Jackson (1976). It should also be appreciated that formation rock exhibiting a high degree of heterogeneity (e.g., fluvial, deltaic, turbidites, carbonates, highly faulted, and highly fractured) also exhibit relatively small volumetric sweep efficiencies (e.g., less than 50%). Thus, the heterogeneity of the formation rock containing the reservoir can also be quantified in terms of its volumetric sweep efficiency. In embodiments, described herein, the formation rock containing the reservoir preferably exhibits a volumetric sweep efficiency less than 50%, and more preferably less than 40%. Thus, formation rock exhibiting a volumetric sweep efficiency less than 50% weighs in favor of waterflooding at VRR<1.0, and a volumetric sweep efficiency less than 40% weighs more heavily in favor of waterflooding at VRR<1.0.

The release of gas from oil in the reservoir while operating at VRR<1.0 offers the potential to activate additional recovery mechanisms. However, the production of such released gas to the surface would reduce and/or eliminate its ability to facilitate mobilization and production of the oil in the reservoir, and indeed, may result in an undesirable decrease in formation pressure. Accordingly, when operating a waterflood at VRR<1.0, it is generally preferred to maintain gas released from the oil at or below the Bubblepoint pressure within the reservoir. In general, the greater the maximum true stratigraphic thickness (TST) of the reservoir, the greater the potential space within the reservoir to capture and hold released gas (instead of allowing the released gas to be produced). Thus, the greater the maximum true stratigraphic thickness (TST)of the reservoir, the more suitable the reservoir to waterflooding at VRR<1.0. In embodiments described herein, the maximum true stratigraphic thickness (TST) of the reservoir is preferably greater than 50 ft., and more preferably greater than 100 ft. In other words, a reservoir having a maximum true stratigraphic thickness (TST) greater than 50 ft. weighs in favor of waterflooding at VRR<1.0, and a reservoir having a maximum true stratigraphic thickness (TST) greater than 100 ft. weighs more strongly in favor of waterflooding at VRR<1.0.

The factor assessed in block 113 relating to existing production information includes the comparison of the production GOR (i.e., the GOR of the production fluids) and the solution GOR (i.e., the GOR of the oil in the reservoir) when (or shortly after) the reservoir pressure drops to or below the Bubblepoint pressure during a waterflood of a reservoir in the same field as the reservoir being assessed or the reservoir being assessed. In particular, embodiments described herein can be applied to reservoirs that have never been produced, reservoirs in fields containing other reservoirs that have been produced or are being produced, or reservoirs that have been produced or are being produced. For instance, embodiments described herein can be applied to fields and reservoirs currently in production to assess whether they can be produced more efficiently and/or with improved economics. If information relating to current production in the same field or reservoir being assessed is available, such information can be used to in block 113 to assess whether waterflooding at VRR<1.0 offers potential advantages. More specifically, during the waterflood of a reservoir, if the reservoir pressure dips to or below the Bubblepoint pressure, one would generally expect the release of some gas from the oil in the reservoir and the subsequent production of some of the released gas. Accordingly, during or shortly after the time period at which the reservoir pressure dips to or below the Bubblepoint pressure, one would expect the production GOR (i.e., the GOR of the production fluids) to increase and exceed the solution GOR (i.e., the GOR of the oil in the reservoir). However, if the production GOR and the solution GOR remain about the same despite the reservoir pressure dipping to or below the Bubblepoint pressure, it suggests the gas released from the oil is not being produced and remains in the reservoir. As previously described, the additional recovery mechanisms triggered by waterflooding at VRR<1.0 rely on the release of gas from the oil in the reservoir. The released gas is preferably maintained in the reservoir, as opposed to being produced, so that it can continue to enable and facilitate the additional recovery mechanisms within the reservoir. Thus, existing production data from the same field as the reservoir being assessed or from the reservoir being assessed that indicates the production GOR and the solution GOR remain about the same despite the reservoir pressure dipping to or below the Bubblepoint pressure suggests the reservoir may be suitable for waterflooding at VRR<1.0. In embodiments described herein, the production GOR is preferably within 10% of the solution GOR despite the reservoir pressure dipping below the Bubblepoint pressure. In other words, existing production data from the waterflood of a reservoir in the same field as the reservoir being assessed or from the reservoir being assessed that indicates the production GOR is less than or equal to 110% of the solution GOR despite the reservoir pressure dipping below the Bubblepoint pressure weighs in favor of waterflooding at VRR<1.0.

It should be appreciated that a conventional waterflood is operated at VRR=1.0 and generally maintains the reservoir pressure above the Bubblepoint pressure. However, in some cases, the reservoir pressure may inadvertently and temporarily dip to or below the Bubblepoint pressure. It is during such instances that the existing production data relating to production GOR and solution GOR are relevant to the assessment of whether another reservoir in the field or the reservoir itself may be suitable for waterflooding at VRR<1.0.

The factors assessed in block 113 relating to the interaction and dynamics of the fluids in the reservoir and the formation rock are derived from plots of the relative permeability of the gas in the reservoir as a function of the gas saturation (Sg) of the reservoir and the water fractional curve (fw) as a function of the gas saturation (Sg) of the reservoir. Plots of the relative permeability of the gas in the reservoir as a function of the gas saturation (Sg) of the reservoir and the water fractional curve (fw) as a function of the gas saturation (Sg) of the reservoir are generally known in the art and are generated using techniques known in the art based on information collected during appraisal of the reservoir in block 111. For example, SPE-174032-MS, “An Experimental Investigation of Viscous Oil Recovery Efficiency as a Function of Voidage Replacement Ratio,” Tae Wook Kim, E. Vittoratos, and A. R. Kovscek (2015), which is hereby incorporated herein by reference in its entirety, outlines one method for generating a plot of the relative permeability of the gas in the reservoir as a function of the gas saturation (Sg) of a reservoir. Plots of the water fractional curve (fw) as a function of the gas saturation (Sg) of the reservoir are less common, and thus, for purposes of clarity, the process for generating such plots will be described in more detail below.

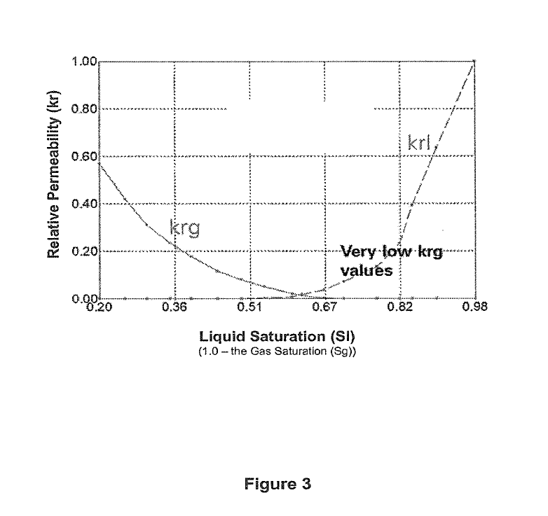

Referring now to FIG. 3, plots of the relative permeability (kr) (Y-axis) of the gas (krg) and the liquid (krl) as a function of the liquid saturation (Sl) (X-axis) of an exemplary reservoir are shown. The gas saturation (Sg) is 1.0 minus the liquid saturation (Sl), and thus, the plot shown in FIG. 3 can also be used to assess the relative permeability of the gas (krg) (Y-axis) in the reservoir as a function of the gas saturation (Sg), which is 1 minus the liquid saturation (Sl). For example, at a gas saturation of about 0.64 (Sl=0.36), the gas relative permeability (krg) is about 0.22.

Analysis of the relative permeability of the gas (krg) in the reservoir as a function of the gas saturation (Sg) of the reservoir provides insight as to how gas is released from the oil in the reservoir and moves through the formation rock containing the reservoir. As previously described, the additional recovery mechanisms triggered by waterflooding at VRR<1.0 rely on the release of gas from the oil in the reservoir, and further, the released gas is preferably maintained in the reservoir, as opposed to being produced, so that it can continue to enable and facilitate the additional recovery mechanisms within the reservoir. In general, the suppression of the gas relative permeability (krg) over a relatively large span of gas saturations (Sg) (moving from a gas saturation of zero, which is equal to a liquid saturation of 1.0) is preferred for waterfloods at VRR<1.0 as it indicates gas released from the oil in the reservoir exhibits little to no movement through the formation rock (i.e., very low mobility) until the gas saturation (Sg) is sufficiently large. Limited movement of released gas suggests released gas remains in the reservoir as opposed to migrating through the reservoir and ultimately produced. This behavior can be due to a variety of factors including, without limitation, the chemistry of the oil and/or the viscosity of the oil from which the gas is released. In embodiments described herein, the gas relative permeability (krg) is preferably less than 0.025 for gas saturations (Sg) less than 0.15 (liquid saturations greater than 0.85), more preferably less than 0.025 for gas saturations (Sg) less than 0.2 (liquid saturations greater than 0.8), and even more preferably less than 0.025 for gas saturations (Sg) less than 0.4 (liquid saturations greater than 0.6). In other words, a numerical simulation of a reservoir that exhibits suppression of the relative permeability of the gas (krg) below 0.025 for gas saturations (Sg) less than 0.15 weighs in favor of waterflooding the reservoir at VRR<1.0, a numerical simulation of a reservoir that exhibits suppression of the relative permeability of the gas (krg) below 0.025 for gas saturations (Sg) less than 0.20 weighs more strongly in favor of waterflooding the reservoir at VRR<1.0, and a numerical simulation of a reservoir that exhibits suppression of the relative permeability of the gas (krg) below 0.025 for gas saturations (Sg) less than 0.4 weighs even more strongly in favor of waterflooding the reservoir at VRR<1.0. In FIG. 3, the gas relative permeability (krg) is suppressed below 0.025 for gas saturations (Sg) less than about 0.40.

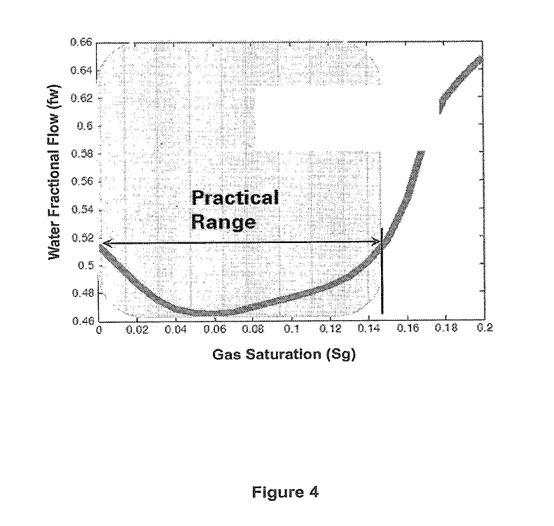

Referring now to FIG. 4, a plot of the water fractional flow (fw) (Y-axis) as a function of the gas saturation (Sg) (X-axis) of an exemplary reservoir is shown. This plot generally illustrates the water fractional flow (fw) in the reservoir, an indicator of the mobility of water injected into the reservoir during a waterflood, as gas saturation (Sg) in the reservoir changes, and can be derived from a typical 3-phase relative permeability model (e.g., Stone II, Baker, Stone I) from the gas-liquid relative permeability and the oil-water relative permeability. For example, this plot can be generated using the following steps: (1) using 2-phase relative permeability curves of water-oil and gas-liquid and a 3-phase algorithm, the relative permeability of the oil in the reservoir (kro), the relative permeability of the water in the reservoir (krw), and the relative permeability of the gas in the reservoir (krg) are determined for the gas saturation (Sg) range, and then plotted in a ternary diagram as known in the art; (2) a certain water saturation (Sw) is selected and the gas saturation (Sg) is set to zero (this is the same as picking a point on the ternary saturation diagraph where Sg is 0); (3) the gas saturation (Sg) is then increased as the water saturation (Sw) and oil saturation (So) are proportionally decreased as the saturation values are moving towards a gas saturation of 1.0 (100%); and (4) the water fractional flow (fw) is calculated using techniques know in the art (e.g., for horizontal reservoirs, fw=(1/(1+(kro/krw*μw/μo)), where μw is the water viscosity and μo is the oil viscosity).

As shown in FIG. 4, the water fractional flow (fw) initially decreases as gas saturation (Sg) increases, and then increases as gas saturation (Sg) continues to increase. This behavior indicates a desirable initial decrease in water mobility as gas saturation (Sg) increases, followed by an undesirable increase in water mobility as gas saturation (Sg) continues to increase. In general, a relatively low water fractional flow (fw) and associated low water mobility suggest the water in the reservoir is not fingering or flowing along preferential paths through the reservoir, whereas a relatively high water fractional flow (fw) and associated high water mobility suggest the water in the reservoir is fingering and flowing along preferential paths through the reservoir. As previously described, the additional recovery mechanisms triggered by waterflooding at VRR<1.0 rely on the release of gas from the oil in the reservoir, which inherently increases the gas saturation (Sg) in the reservoir. Accordingly, for waterflooding at VRR<1.0, it is preferred that the water mobility in the reservoir remain relatively low (e.g., equal to or less than the mobility of water in the absence of released gas) as gas saturation (Sg) in the reservoir increases, at least initially, due to the release of gas from the oil in the reservoir at or below the Bubblepoint pressure. For embodiments described herein, the water fractional flow (fw) at a gas saturation (Sg) of 0.15 is preferably equal to or less than the water fractional flow (fw) at a gas saturation (Sg) of 0.0, which indicates the water mobility at a gas saturation (Sg) of 0.15 is no worse than the water mobility at a gas saturation (Sg) of zero (i.e., a pure waterflood at VRR=1.0). In FIG. 4, the water fractional flow (fw) deceases from a gas saturation (Sg) of 0.0 to a gas saturation (Sg) of about 0.05, and then increases for gas saturations (Sg) greater than about 0.06. However, the water fractional flow (fw) at a gas saturation of 0.15 is about the same as the water fractional flow (fw) at a gas saturation (Sg) of 0.0.

The range of gas saturations (Sg) from 0.0 to the gas saturation (Sg) at which the water fractional flow (fw) is the same as the water fractional flow (fw) at the gas saturation (Sg) of 0.0 defines a reasonable or practical operating range for gas saturation (Sg) during a waterflood at VRR<1.0 because at any gas saturation (Sg) within that range, the water fractional flow (fw) is no worse than it would be at VRR=1.0 (equivalent to a gas saturation (Sg) of 0.0). Thus, the water fractional flow (fw) versus gas saturation (Sg) plot can be used during actual waterfloods at VRR<1.0 to manage the time duration at which VRR is maintained below 1.0 to ensure the gas saturation (Sg) in the reservoir are maintained within a practical range associated with acceptable water mobilities. In FIG. 4, gas saturations (Sg) between 0.0 and about 0.15 define a practical operating range for gas saturations (Sg) during a waterflood at VRR<1.0 because the water fractional flow (fw) at all gas saturations (Sg) up to about 0.15 are no worse than the water fractional flow (fw) at the gas saturation (Sg) of 0.0—at gas saturations (Sg) above about 0.15, the water mobilities exceed the water mobility at a gas saturation (Sg) of 0.0, which suggests the additional recovery mechanisms triggered by VRR<1.0 are not being fully leveraged.

An additional factor assessed in block 113 relating to the interaction and dynamics of the fluids in the reservoir and the formation rock is the critical gas saturation (Sgc) of the reservoir. In general, a higher critical gas saturation (Sgc) is preferred for waterfloods at VRR<1.0. In particular, as gas starts to be released from oil in the reservoir, it is generally preferred that the gas remain dispersed in the oil, thereby offering the potential to activate solution gas drive to push oil from “cul de sacs” or regions of the formation that are not adequately swept by water. In general, the gas will not move through the reservoir until the gas saturation (Sg) is at least equal to the critical gas saturation (Sgc). In embodiments described herein, the critical gas saturation (Sgc) of the reservoir is preferably greater than 0.04. In other words, a critical gas saturation (Sgc) greater than 0.04 weighs in favor of waterflooding at VRR<1.0.

The factor assessed in block 113 relating to well spacing is the minimum distance between each well pair (i.e., any one injection well and any one production well) as defined in block 112. In general, the larger the minimum distance between each well pair, the greater the potential effect of the additional recovery mechanisms triggered by VRR<1.0. In embodiments described herein, the minimum distance between each well pair is preferably greater than 1,300 ft., and more preferably greater than 2,000 ft. In other words, a minimum distance between each well pair greater than 1,300 ft. weighs in favor of waterflooding at VRR<1.0, and a minimum distance between each well pair greater than 2,000 ft. weighs more heavily in favor of waterflooding at VRR<1.0.

Referring again to FIG. 1, the factors described above are analyzed and balanced to determine whether waterflooding at VRR<1.0 offers potential benefits. As noted above, a threshold issue in the assessment is whether the Bubblepoint pressure of the oil in the reservoir is greater than 60% of the reservoir pressure. If this is the case, then the remaining factors are analyzed and balanced to determine whether waterflooding at VRR<1.0 offers potential benefits. In general, the greater the number of factors that weigh in favor of waterflooding at VRR<1.0, the greater the potential benefits of waterflooding at VRR<1.0, and hence, the stronger the suggestion that waterflooding at VRR<1.0 should be considered. It should be appreciated that the balancing of factors may vary from reservoir to reservoir, and may depend on the degree to which certain factors weigh in favor of or against waterflooding at VRR<1.0. In addition to the Bubblepoint pressure of the oil in the reservoir being greater than 60% of the reservoir pressure, in embodiments described herein, preferably at least two, more preferably at least three, more preferably at least four, and even more preferably at least five of the factors weigh in favor of waterflooding at VRR<1.0. In other words, if the Bubblepoint pressure of the oil in the reservoir being greater than 60% of the reservoir pressure and at least two of the other factors weigh in favor of waterflooding at VRR<1.0, then method 100 continues to the second stage 120.

Referring still to FIG. 1, if the factors assessed in block 113 suggest the reservoir is a candidate for waterflooding at VRR<1.0, then the second stage 120 of method 100 begins in block 121 by (i) selecting an initial set of VRR<1.0 parameters, (ii) performing a numerical simulation of a waterflood of the reservoir at VRR=1.0 in block 121 using the infrastructure parameters defined in block 112, and (iii) performing numerical simulations of waterfloods of the reservoir at VRR<1.0 using the infrastructure parameters defined in block 112. The initial set of VRR<1.0 parameters are used in the numerical simulations of waterfloods of the reservoir at VRR<1.0, and thus, are selected before performing the numerical simulations of waterfloods of the reservoir at VRR<1.0. The VRR<1.0 parameters include the actual value of VRR<1.0 (e.g., VRR=0.6) and the period of time to maintain VRR<1.0. In embodiments described herein, the initial set of VRR<1.0 parameters include VRR values of 0.5, 0.7, and 0.9 and time periods, expressed as percentages of the expected life or remaining life of the reservoir, of 20%, 50%, and 70%.

The numerical simulation of a waterflood of the reservoir at VRR=1.0 is performed for the expected life or remaining life of the reservoir. Whereas the numerical simulations of waterfloods of the reservoir at VRR<1.0 are performed for all combinations of VRR<1.0 values (i.e., VRR=0.5, 0.7, and 0.9) and time periods (i.e., 20% of the expected life or remaining life of the reservoir, 50% of the expected life or remaining life of the reservoir, and 70% of the expected life or remaining life of the reservoir). In general, the numerical simulations at VRR=1.0 and VRR<1.0 are performed using techniques known in the art. As is known in the art, during numerical simulations of a waterflood (VRR=1.0 and VRR<1.0), appropriate operational constraints are taken into account including, without limitation, ensuring a reservoir pressure that is sufficient to enable production lift, drilling and completion operations, and avoid undesired compaction.

Moving now to block 122, the numerical simulations of the reservoir at VRR=1.0 and VRR<1.0 are analyzed and compared to determine the relative performance of VRR=1.0 and VRR<1.0. More specifically, the numerical simulations of the reservoir at VRR=1.0 and VRR<1.0 are analyzed and compared to determine whether any of the waterflood simulations at VRR<1.0 yielded better results than the waterflood at VRR=1.0. Although there are a variety of means known in the art for analyzing and comparing results of numerical simulations of waterfloods, in embodiments described herein, the recovery factors (RF) as a function of injected pore volume and the recovery factors (RF) as a function of time for VRR=1.0 and VRR<1.0 are compared.

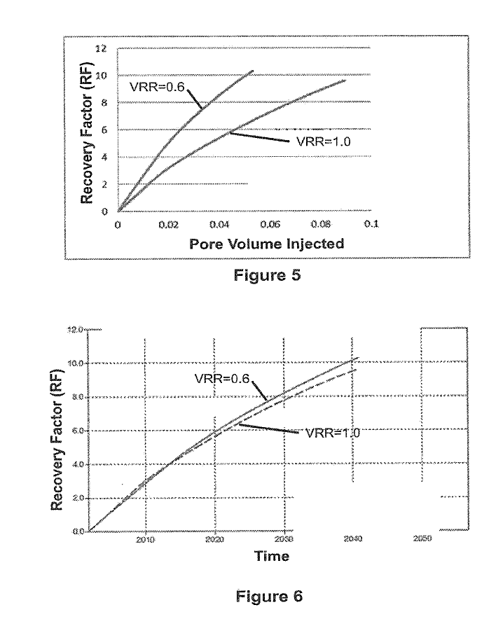

Referring now to FIG. 5, plots of the recovery factor (RF) as a function of pore volume injected for a waterflood simulation of an exemplary reservoir at VRR=1.0 and a waterflood simulation of the same exemplary reservoir at VRR<1.0 (VRR=0.6) are shown on the same graph. These plots are derived from the numerical simulations performed in block 121 using techniques known in the art. As is known in the art, pore volume injected=(volume of water injected*water volumetric factor)/(reservoir area*net thickness*porosity); and water volumetric factor=(volume of water at the reservoir pressure and temperature)/(volume of water at atmospheric pressure and 60° F.).

The curves in FIG. 5 indicate the amount of oil in place recovered for the total water injected for a waterflood of the reservoir at VRR=1.0 and a waterflood of the same reservoir at VRR<1.0 (VRR=0.6). In general, the greater the recovery factor for a given pore volume injected, the more efficient the waterflood. A larger recovery factor for a given pore volume injected also suggests the following potential benefits: less injection wells can be used to recovery the same quantity of oil in place, lower water injection rates can be used to recovery the same quantity of oil in place, and the longer that water injection upgrades/enhancements can be delayed while maintaining a given production rate. Thus, a curve of the recovery factor (RF) as a function of pore volume injected for a waterflood simulation of a reservoir at VRR<1.0 that is disposed above (i.e., is greater than or equal to) the curve of the recovery factor (RF) as a function of pore volume injected for a waterflood simulation of the same reservoir at VRR=1.0 at any given pore volume injected indicates waterflooding the reservoir at VRR<1.0 is more efficient, and hence better, than waterflooding the reservoir at VRR=1.0 at that pore volume injected. This in turn, indicates the additional recovery mechanisms activated by waterflooding at VRR<1.0 offer the potential to enhance overall recovery from the reservoir for that given pore volume injected. In embodiments described herein, a comparison of the curves of the recovery factor (RF) as a function of pore volume injected for a waterflood simulation of a reservoir at VRR<1.0 and VRR=1.0 that illustrates the recovery factor (RF) for VRR<1.0 is greater than or equal to the recovery factor (RF) for VRR=1.0 at an anticipated pore volume injected and/or over a range of anticipated pore volumes injected indicates the performance of waterflooding of the reservoir at VRR<1.0 is more efficient and better than the performance of waterflooding of the same reservoir at VRR=1.0. In FIG. 5, the curve of the recovery factor (RF) as a function of pore volume injected for the waterflood simulation of a reservoir at VRR=0.6 is greater than the curve of the recovery factor (RF) as a function of pore volume injected for a waterflood simulation of the same reservoir at VRR=1.0 for all values for pore volume injected.

As will be described in more detail below, the plots of the recovery factor (RF) as a function of pore volume injected for a waterflood simulation of a reservoir at VRR<1.0 can be used to revise the operational parameters in block 124 in method 100 shown in FIG. 1 if particular pore volumes injected are particularly preferred. For instance, the water injections systems initially defined in block 112 can be revised or updated to achieve a particular range of pore volume injected suggested as being particularly efficient. In addition, the plots of the recovery factor (RF) as a function of pore volume injected for a waterflood simulation of a reservoir at VRR<1.0 can be used during actual production operations to ensure the pore volume injected during the waterflood is maintained within a preferred range.

Referring now to FIG. 6, plots of the recovery factor (RF) as a function of time (expressed in years starting in the year 2000) for a waterflood simulation of an exemplary reservoir at VRR=1.0 and a waterflood simulation of the same exemplary reservoir at VRR<1.0 (VRR=0.6) are shown on the same graph. These plots are derived from the numerical simulations performed in block 121 using techniques known in the art.

The plots in FIG. 6 indicate the amount of oil in place recovered over time (e.g., life of the reservoir) for a waterflood of the reservoir at VRR=1.0 and a waterflood of the same reservoir at VRR<1.0 (VRR=0.6). In general, the greater the recovery factor at any point in time, the greater the amount of oil in place recovered up to that point in time. A curve of the recovery factor (RF) as a function of time for a waterflood simulation of a reservoir at VRR<1.0 that is disposed above (i.e., is greater than or equal to) the curve of the recovery factor (RF) as a function of time for a waterflood simulation of the same reservoir at VRR=1.0 at any given time indicates waterflooding the reservoir at VRR<1.0 is more efficient, and hence better, than waterflooding the reservoir at VRR=1.0 up to that point in time. This in turn, indicates the additional recovery mechanisms activated by waterflooding at VRR<1.0 offer the potential to enhance overall recovery from the reservoir up to that point in time. In embodiments described herein, a comparison of the curves of the recovery factor (RF) as a function of time for a waterflood simulation of a reservoir at VRR<1.0 and VRR=1.0 that illustrates the recovery factor (RF) for VRR<1.0 is greater than or equal to the recovery factor (RF) for VRR=1.0 over a period of time (e.g., life of the reservoir) indicates the performance of waterflooding of the reservoir at VRR<1.0 is more efficient and better than the performance of waterflooding of the same reservoir at VRR=1.0 over that period of time. In FIG. 6, the curve of the recovery factor (RF) as a function of time for the waterflood simulation of the reservoir at VRR=0.6 is greater than the curve of the recovery factor (RF) as a function of time for a waterflood simulation of the same reservoir at VRR=1.0 for all periods of time after about the first 15 years of production.

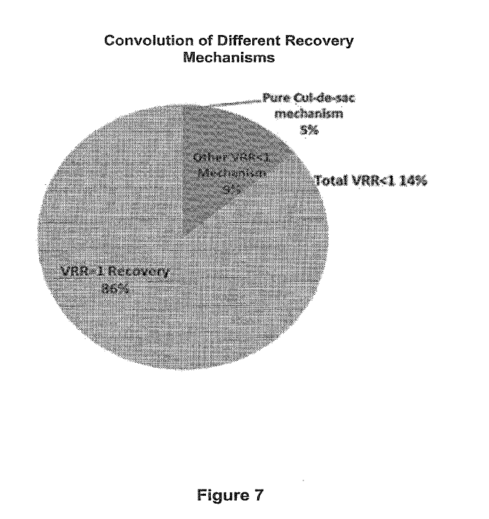

Referring now to FIG. 7, a pie chart illustrating the percentage of oil in place recovered from a reservoir during a numerical simulation as a result of the additional recovery mechanisms triggered by VRR<1.0 and as a result of traditional waterflooding mechanisms at VRR=1.0 is shown. In other words, the pie chart shown in FIG. 7 illustrates the split of the different recovery mechanisms at play and indicates how much the additional recovery mechanisms triggered by VRR<1.0 contribute to the total recovery of the oil in place. In general, the greater the percentage of recovery due to the additional recovery mechanisms triggered by VRR<1.0, the greater the potential benefits of waterflooding the reservoir at VRR<1.0.

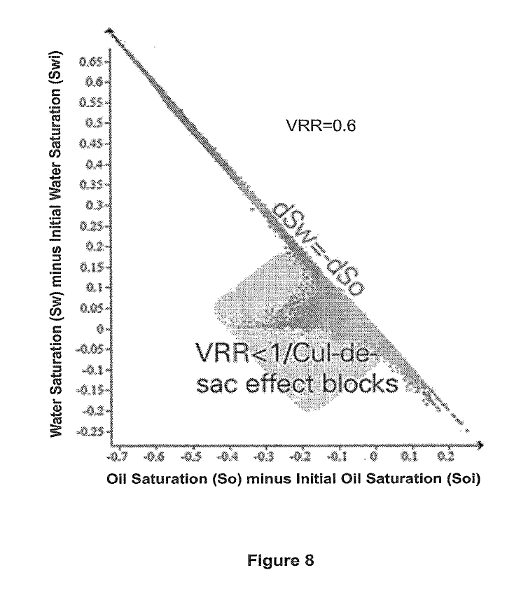

The pie chart shown in FIG. 7 is generated from numerical simulation data. In particular, using techniques known in the art, (Sw-Swi) versus (So-Soi) for each cell or grid block in the numeral simulation of a waterflood at VRR<1.0 is plotted. As is known in the art, Sw and So are the water and oil saturation, respectively, at the chosen evaluation time or end of field life and, Swi and Soi are the initial water and oil saturation, respectively. A plot of (Sw-Swi) (Y-axis) versus (So-Soi) (X-axis) for each cell in the numeral simulation model of an exemplary reservoir waterflooded at VRR=0.6 is shown in FIG. 8. For cells that experience only water displacement (without gas presence) (i.e., cells that do not see any released gas or effects of VRR<1.0), referred to as “pure waterflood” or “VRR=1” cells, the changes in water saturation are the same or substantially the same as the changes in oil saturation, and thus, (Sw-Swi)=−1*(So-Soi). These cells lie along the diagonal line in the positive (Sw-Swi) region (i.e., positive portion of the Y-axis) in FIG. 8. For cells that see gas released from the oil and the affects of VRR<1.0, referred to as “VRR<1” cells, the changes in the oil saturation are greater than the changes in the water saturation, and thus, −1×(So-Soi)>(Sw-Swi) (i.e., more oil is displaced than water saturation change in that cell). Such cells are positioned below the diagonal line in the positive (Sw-Swi) region (i.e., positive portion of the Y-axis) in FIG. 8. Among the VRR<1 cells (i.e., among the cells positioned below the diagonal line in FIG. 8), the particular cells that experience “cul-de-sac” effects, referred to as “cul-de-sac” cells,” described in more detail below, are distributed along the horizontal edge proximal (Sw-Swi)=0 and represent cells with little to no change in water saturation. The remaining VRR<1 cells (i.e., the cells positioned below the diagonal line in FIG. 8 that are not cul-de-sac cells) experience additional recovery mechanisms triggered by VRR<1.0 other than “cul-de-sac” effects such as solution gas drive and three-phase relative permeability effects in the water swept region.

Referring now to FIGS. 7 and 8, using the information from the (Sw-Swi) versus (So-Soi) plot resulting from the numeral simulation of the waterflood at VRR<1.0 (e.g., FIG. 8), the cells with saturation changes are identified and categorized as VRR=1.0 cells, VRR<1 cells, and cul-de-sac cells within the VRR<1 cells. Next, the incremental oil can be calculated for each cell and the pie chart can be prepared identifying the percentage of the oil recovered via each category as shown in FIG. 8. In the example shown in FIG. 8, it is estimated that of the total oil recovery from this model, 14% is attributable to the additional recovery mechanism triggered by VRR<1.0, and of that, about 5% results from cul-de-sac effects and 9% results from the other additional recovery mechanism triggered by VRR<1.0.

Referring again to FIG. 1, if the comparison of the recovery factors as a function of injected pore volume for any combination of the initial set of VRR<1.0 parameters indicates VRR<1.0 is more efficient than VRR=1.0, and/or the comparison of the recovery factors as a function of time for any combination of the initial set of VRR<1.0 parameters is greater than or equal to VRR=1.0 over a predetermined or desired time period, the analysis and comparison of the numerical simulations of VRR=1.0 and VRR<1.0 in block 122 indicates waterflooding the reservoir at a VRR<1.0 offers potential advantages over waterflooding the reservoir at VRR=1.0. Accordingly, if this is the case, method 100, and in particular second stage 120, continues in block 123 with an economic assessment of the numerical simulation of VRR=1.0 and each numerical simulation of VRR<1.0 (for all combinations of VRR<1.0 values and time periods). In general, the economic assessments of the different simulations are performed using standard economic models known in the art and consider economic factors such as Net Present Value, Internal Rate of Return, and Pay back period.

Next, the operational parameters for producing the reservoir (i.e., the infrastructure parameters defined in block 112 and the VRR<1.0 parameters selected in block 121) are revised in block 124 to maximize the economics of waterflooding the reservoir at VRR<1.0. It should be appreciated that for reservoirs that have already been produced, the infrastructure parameters may not be capable of being changed as the wells, injection systems, and production systems may already in place, however, for reservoirs that have not yet been produced, the infrastructure parameters may be capable of being changed. In general, any of the operational parameters can be revised, however, in embodiments described herein, the infrastructure parameters that are revised include the minimum spacing between each injection well and each production well, the number of wells (number of injection wells and number of production wells), and the water injection capacity (volumetric flow rate of water that can be supported by the injection system); and the VRR<1.0 parameters that are revised include the VRR<1.0 value (e.g., VRR=0.8) and the period of time at which to maintain VRR<1.0 (e.g., 60% of the reservoir life). Although the minimum spacing between each injection well and each production well, the number of wells, the water injection capacity, the VRR<1.0 value, and the period of time to maintain VRR<1.0 can be revised at any desired level of granularity and detail, to minimize the number of combinations of operational parameters that are assessed to a reasonable amount, in embodiments described herein, the spacing between each injection well and each production well is changed in increments of 100 ft., the number of wells (injection wells and production wells) are changed in increments of one, the water injection capacity is changed in increments of 10% of the initial injection capacity defined in block 112, the VRR<1.0 values are changed in increments of 0.1, and the duration of time to maintain VRR<1.0 is changed in one year increments.

Waterflooding at VRR<1.0 is particularly well suited for large well spacings where there is potentially a large amount of oil in place bypassed between the injection and production wells. The additional recovery mechanism activated by VRR<1.0 offer the potential to increase the oil recovery in a more profound way in such applications. Accordingly, in many cases, the well spacing is increased in block 124 to enhance the economic benefits of waterflooding at VRR<1.0.

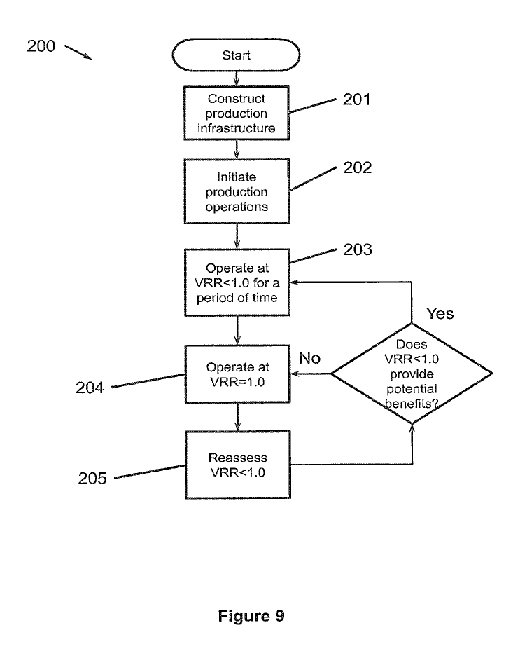

Blocks 121, 122, 123 are then repeated using the revised operational parameters. The process of revising the operational parameters in block 124 followed by blocks 121, 122, 123 is repeated to maximize the economics of the waterflood at VRR<1.0. Those operational parameters that maximize the economics of the waterflood at VRR<1.0 represent outputs of method 100, which are then implemented to produce the reservoir in method 200 shown in more detail in FIG. 9.

Referring now to FIG. 9, an embodiment of a method 200 for producing a reservoir via waterflood using the operational parameters output from method 100 previously described is shown. Method 200 begins in block 201, where the production infrastructure is constructed in accordance with the infrastructure parameters output from method 100 (e.g., the number, location, spacing, and layout of the injection wells and production wells; the water injection system having the predetermined capacities; and the production system having the predetermined capacities) (e.g., type of artificial lift and associated production volume, pressure, and rate capacities).

Next, the waterflood is initiated in block 202, and in block 203, the VRR of the waterflood is conducted in accordance with the VRR<1.0 parameters (i.e., VRR<1.0 value and duration of VRR<1.0). More specifically, the VRR is set to the revised VRR<1.0 value (e.g., VRR=0.7) output in block 124. In this embodiment, the waterflood is initiated in accordance with the VRR<1.0 parameters in block 202 and continues in block 203 for a period of time. However, in other embodiments, the waterflood can be initiated at VRR=1.0 in block 202, and the transitioned to VRR<1.0 in block 203. In general, the VRR can be lowered by reducing the water injection rate and/or increasing the production rate. For example, the VRR can be lowered by ensuring the injection rate of the displacement fluid (i.e., water or fluid comprising water) is less than the production rate of production fluids (e.g., oil, water, gas, etc.), generally referred to as “underinjecting.” Underinjecting can be achieved by reducing the injection rate, increasing the production rate, or simultaneously reducing the injection rate while increasing the production rate.

The VRR<1.0 parameters output from block 124 define a period of time for which to maintain the waterflood at VRR<1.0. However, to control and manage the undesirable production of free gas (i.e., gas released from the oil when the reservoir pressure drops to or below the Bubble point pressure), the production GOR (i.e., the GOR of the production fluids) is preferably monitored during waterflooding at VRR<1.0 to ensure it remains within 30% of the solution GOR (i.e., the GOR of the oil in the reservoir). The waterflood is transitioned from VRR<1.0 to VRR=1.0 in block 204 when the production GOR exceeds the solution GOR by more than 30% or at the end of the predetermined time period for operating at VRR<1.0 defined in the VRR<1.0 parameters in block 124, whichever occurs first.

After the waterflood is transitioned from VRR<1.0 to VRR=1.0, it is operated at VRR=1.0 while the reservoir is continuously or periodically reassessed for a potential transition back to VRR<1.0 in block 205. In this embodiment, the reassessment in block 205 is performed via the second stage 120 previously described. If the reassessment in block 205 indicates further potential advantages to a transition back to VRR<1.0, then waterflood is transitioned back to VRR<1.0, and in particular, transitioned to VRR<1.0 in accordance with the VRR<1.0 parameters defined in the reassessment (i.e., via repeating the second stage 120). However, if the reassessment in block 205 indicates there are little to no potential advantages to a transition back to VRR<1.0, then the waterflood is maintained at VRR=1.0.

In the manner described, embodiments of methods for determining the operational parameters of a waterflood at VRR<1.0 for a specific reservoir are disclosed, as well as methods for implementing the operational parameters to produce the reservoir via waterflood at VRR<1.0. Waterfloods operated at VRR<1.0 for a period of time followed by VRR=1.0 offer the potential for improved recovery and economics. The process of operating the waterflood at VRR<1.0 followed by VRR=1.0 can be cycled (i.e., VRR<1.0 followed by VRR=1.0, followed by VRR<1.0, followed by VRR=1.0, etc.). Although any suitable number of cycles of VRR<1.0 followed by VRR=1.0 can be performed depending on the reassessment of VRR<1.0 (e.g., in block 205), it is believed that in practice, three or fewer cycles of VRR<1.0 followed by VRR=1.0 are preferred. The VRR<1.0 parameters (e.g., the time to initiate VRR<1.0, the particular VRR for each period of VRR<1.0, and the time period to maintain VRR<1.0 in each period) may vary on a case-by-case basis, but will usually depend, at least in part, on the factors assessed in block 113.

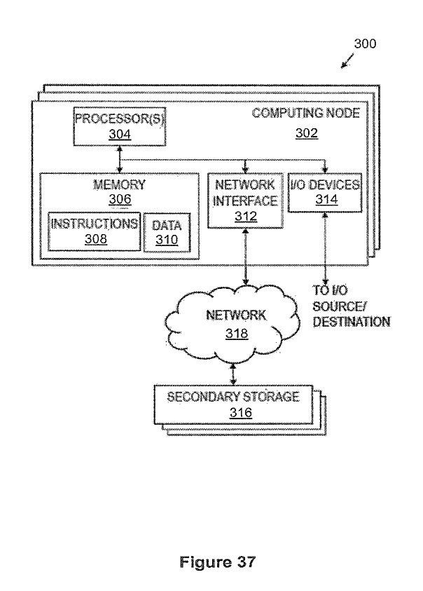

Referring briefly to FIG. 37, a schematic diagram of a computing system 300 suitable for performing one or more operations in methods 100, 200 described above is shown. The computing system 300 includes one or more computers or computing nodes 302 and secondary storage 316 that are communicatively coupled via a network 318. One or more of the computers 302 and associated secondary storage 316 may be employed to provide at least some of the functionality employed in methods 100, 200 including those operations or processes performed in blocks 113, 121, 122, 123, 124, and 205.

Each computer 302 includes at least one processor 304 coupled to memory 306, a network interface 312, and input/output (I/O) devices 314. In some embodiments, a computer 302 may implement the functionality of more than operation in method 100 and/or method 200. A computer 302 may be a uniprocessor system including one processor 804, or a multiprocessor system including several processors 804 (e.g., two, four, eight, or another suitable number). In general, processors 804 may be any suitable processor capable of executing instructions. For example, in various embodiments, processors 804 may be general-purpose or embedded microprocessors implementing any of a variety of instruction set architectures (ISAs). In multiprocessor systems, each processor 804 may commonly, but not necessarily, implement the same ISA. Similarly, in a distributed computing system such as one that collectively implements one or more operations in methods 100, 200, each of the computers 302 may implement the same ISA, or individual computers and/or replica groups of computers may implement different ISAs.

In general, the memory 306 may include a non-transitory, computer-readable storage medium configured to store program instructions 808 and/or data 810 accessible by processor(s) 804. The system memory 306 may be implemented using any suitable memory technology, such as static random access memory (SRAM), synchronous dynamic RAM (SDRAM), nonvolatile/Flash-type memory, or any other type of memory. Program instructions 308 and data 302 implementing the functionality disclosed herein are stored within system memory 306. For example, instructions 308 may include instructions that when executed by processor(s) 304 implement the operations in blocks 113, 121, 122, 123, 124, 205 and/or other operations disclosed herein.

In general, secondary storage 316 may include volatile or non-volatile storage and storage devices for storing information such as program instructions and/or data as described herein for implementing methods 100, 200. The secondary storage may include various types of computer-readable media accessible by the computers 302 via the network 318. A computer-readable medium may include storage media or memory media such as semiconductor storage, magnetic or optical media, e.g., disk or CD/DVD-ROM, or other storage technologies. Program instructions and data stored on the secondary storage 316 may be transmitted to a computer 302 for execution by a processor 804 by transmission media or signals via the network 318, which may be a wired network, a wireless network, or combinations thereof.

The network interface 312 may be configured to allow data to be exchanged between computers 302 and/or other devices coupled to the network 318 (such as other computer systems, communication devices, input/output devices, or external storage devices). The network interface 312 may support communication via wired or wireless data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

In general, I/O devices 314 may include one or more display terminals, keyboards, keypads, touchpads, scanning devices, voice or optical recognition devices, or any other devices suitable for entering or retrieving data by one or more computers 302. Multiple input/output devices 314 may be present in a computer 302 or may be distributed on various computers 302 of the system 300. In some embodiments, similar input/output devices may be separate from computer 302 and may interact with one or more computers 302 through a wired or wireless connection, such as over network interface 312.

It is to be understood that computing system 300 is merely illustrative and is not intended to limit the scope of embodiments. In particular, the computing system 300 may include any combination of hardware or software that can perform the functions disclosed herein, including computers, network devices, internet appliances, PDAs, wireless phones, pagers, etc. Computer 302 may also be connected to other devices that are not illustrated. In addition, the functionality provided by the illustrated components may be combined in fewer components or distributed in additional components. Similarly, the functionality of some of the illustrated components may not be provided and/or other additional functionality may be available.

It should also be understood that the functionality disclosed herein may be provided in alternative ways, such as being split among more software modules or routines or consolidated into fewer modules or routines. Similarly, methods may provide more or less functionality than is described, such as when other illustrated methods instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. The various methods as depicted in the figures and described herein represent illustrative embodiments of methods. The methods may be implemented in software, in hardware, or in a combination thereof in various embodiments. Similarly, the order of any method may be changed, and various elements may be added, reordered, combined, omitted, modified, etc., in various embodiments.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

To further illustrate the additional recovery mechanisms activated by waterflooding at VRR<1.0, the following examples are provided.

### EXAMPLE 1

### Three Phase Relative Permeability Interference and Solution Gas Drive in One-Dimension (1D)

The fundamental aspects of the VRR<1.0 process in a 1D system were studied and analyzed, isolating the mechanisms of solution gas drive and three phase relative permeability, while incorporating the concomitant viscosity increases. The tested 1D system was not limited by practical issues such as artificial lift bottomhole pressure (BHP) limits.

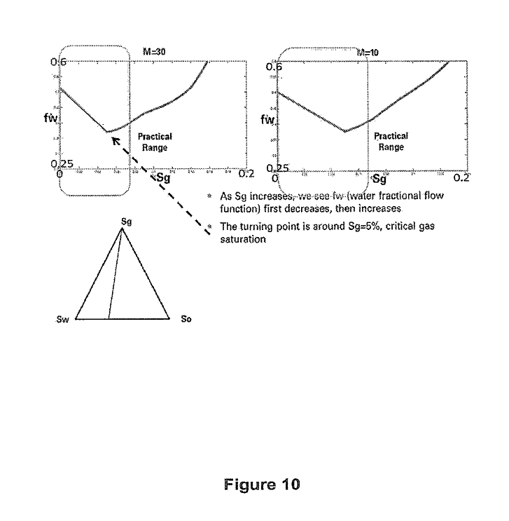

The first test case was a viscous oil 1D VRR<1.0 numerical simulation with a critical gas saturation (Sgc) of 5%. The 1D problem had small dimensions as follows: 5 feet length and 0.83 feet by 0.83 feet in cross-section. The model was homogeneous with a porosity of 0.35 and a permeability of 4000 mD. The initial pressure was 1500 psi. The injector well was on the left side and the producer well was on the right side. Using the Stone II algorithm, FIG. 10 illustrates the 3-phase relative permeability effects for this test—as the gas saturation increased, the kro initially increases but then decreases. To have positive effect in slowing down the water break through (i.e., lowering the fw value), it is preferred that the gas saturation (Sg) be kept within a certain range, not too high, as shown in FIG. 10. This suggested that in practice, VRR<1.0 should be implemented for a finite period of time so that the gas saturation (Sg) in the reservoir is maintained within a lower range.

To implement the VRR<1.0 process, the water injection rate can be reduced and/or the production rate can be increased. It is not uncommon that commercial waterflood projects are injectivity limited, and thus, simulations that achieve VRR<1.0 by increasing production are more representative of commercial realities. This does raise, however, the possibility that the response may be at least in part an acceleration of production rather than a true incremental recovery. However, the agreement of both ways of achieving VRR<1.0 indicates that acceleration effects are insignificant in the 1D model.

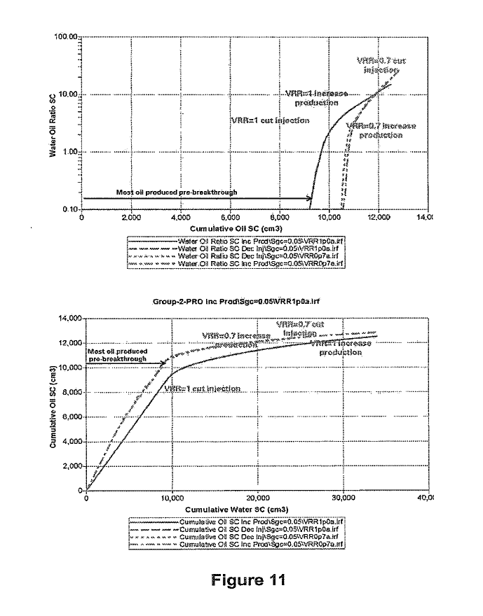

As shown in FIG. 11, in the 1D model, most of the production occurred prior to water breakthrough. In commercial heavy oil waterfloods most of the production occurs after water breakthrough. Thus, the 1D model may tend to underestimate the role of relative permeability interference between the phases compared to commercial recovery processes. The following observations were also made:
1. The total oil production prior to water breakthrough was significantly larger for VRR<1.0 than with VRR=1. The increase equaled approximately 5% of the original OIP (˜1400 cc), suggesting that the 5% Sgc primarily drove the extra oil.
2. For a given quantity of water injected, VRR<1.0 recovered significantly more oil than VRR=1. On a time basis, however, the recovery with VRR<1.0 was less than with VRR=1 because of the slower injection of the displacing water.

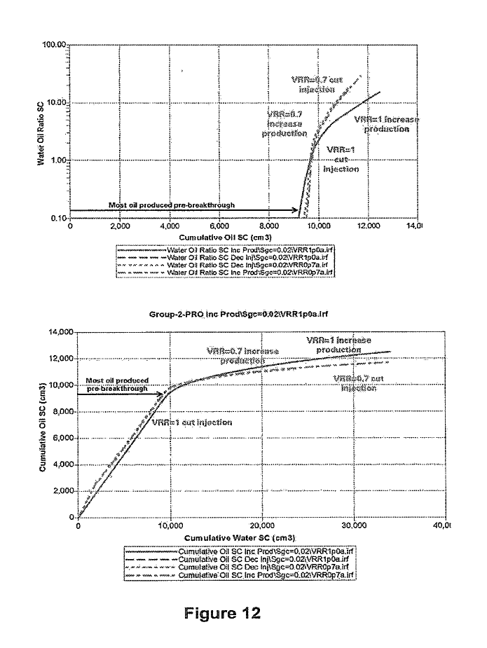

A case with the smaller critical gas saturation (Sgc) of 2%, while keeping everything else the same, was also tested as shown in FIG. 12. A smaller improved oil recovery was observed. In addition, the delay in water production was much smaller, and the incremental recovery with VRR<1.0 for a given quantity of water injection was marginal early on, but after breakthrough the VRR=1 was a more efficient process. This again suggests that in voidage management during waterfloods, VRR<1.0 should be of finite duration and relatively early on in the process. It is believed that the negative impact of longer duration VRR<1.0 is related to the increased oil viscosity as the pressure is reduced.

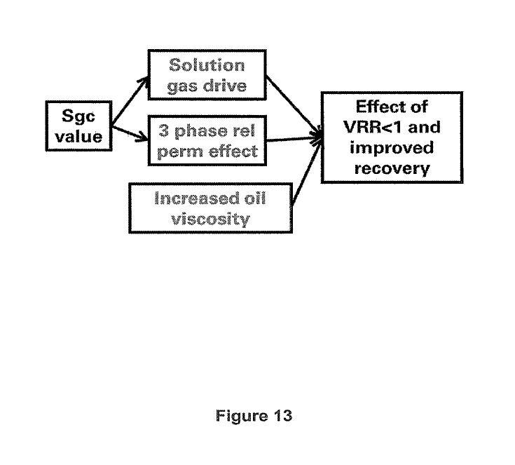

In summary, the 1D system was controlled by three mechanisms: critical gas saturation (Sgc), the three phase relative permeability interference, and viscosity increase with the decline of pressure with VRR<1.0. Emulsion flow behavior was not included in these tests. Results indicated that critical gas saturation (Sgc) was a particularly critical parameter for oil recovery and controls most of the observations. This may not, however, be a general result for other relative permeability curves, particularly for foamy behavior where a high critical gas saturation (Sgc) is accompanied with suppressed gas relative permeability (krg) values for a large range of gas saturation (Sg) beyond the critical gas saturation (Sgc). Losing solution gas typically makes the oil more viscous, which may result in a negative effect on the fractional flow of the system by raising the equivalent mobility ratio. These three effects in aggregate control the final effect of VRR<1 and improved recovery in the 1D simulations as shown in FIG. 13.

### EXAMPLE 2

### Cul-de-sac Mechanism Deconvolution and Quantification

The distribution and magnitude of the cul-de-sac mechanism was analyzed, deconvolving the cul-de-sac mechanism from other effects in VRR<1.0. Considering flow through a porous formation, there are through interconnected voids defining passages through the formation and cul-de-sac regions or “dangling ends” extending from the backbones to a terminal end. If there are no dangling ends, the entire interconnected region can be swept by a waterflood. However, in cases where there are dangling ends in the formation, those regions often remain unswept by the waterflood unless there is some internal displacement power to move the contents from the dangling ends into the passages. The VRR<1.0 process offers the potential to activate the solution gas drive and foamy oil mechanisms within the dangling ends so that additional recovery can be achieved, referred to herein as the “cul-de-sac” mechanism.

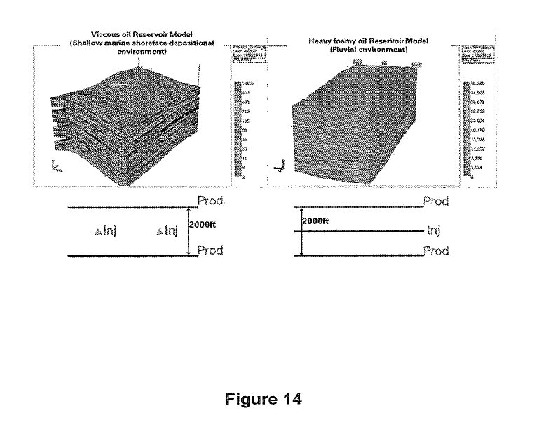

Two simulation models were analyzed to study the cul-de-sac mechanism—a type pattern model (TPM) for a shallow marine shoreface viscous oil reservoir and a type pattern model (TPM) for a fluvial heavy oil reservoir with foamy oil behavior. The permeability and well configurations of the two TPM simulation models are shown in FIG. 14. The viscous oil model included two horizontal tri-lateral producer wells and two vertical injector wells perforated to multiple zones. To simplify and enhance transparency, only one flow unit was flooded, the one in the middle in this TPM. Thus, it was equivalent to having two single lateral horizontal producer wells and two single zone injector wells. The heavy oil reservoir model included one single lateral horizontal injector well and two single lateral horizontal producer wells. In both cases, the well spacing between producers was 2,000 feet.

The heavy oil model was waterflooded with a viscosified injectant (˜50 cp viscosity injectant.), whereas the viscous oil model underwent a normal waterflood (i.e., without viscosification of the injectant). In the heavy oil model, the water was viscosified to achieve similar mobility ratio as the viscous oil model. Thus, the two models had similar order of magnitude mobility ratios. All VRR<1.0 effects (e.g., heterogeneity, solution gas drive, three phase relative permeability interference) except emulsion flow were represented in these models. The heavy oil model exhibited a gas relative permeability that mimicked foamy oil drive, while the viscous model exhibited a gas relative permeability that mimicked light oil solution gas drive. This example had a critical gas saturation (Sgc) of 0.02, however, in general, Sgc is variable up to about 0.07.

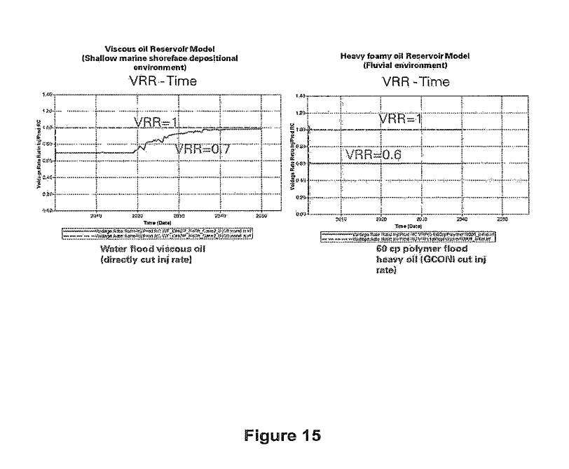

Simulation of VRR=1 and the VRR<1.0 processes were conducted on these two models, with their VRR history shown in FIG. 15. It was observed that the viscous oil model sustained VRR=0.7 production by cutting the injection rate to 70% for the initial 20 years. In the next 30 years, the producer wells hit the minimal BHP control and the production wells change to a lower rate, with VRR=0.7 no longer sustained. In the heavy oil model, the VRR=0.6 was sustained throughout the life of the field.

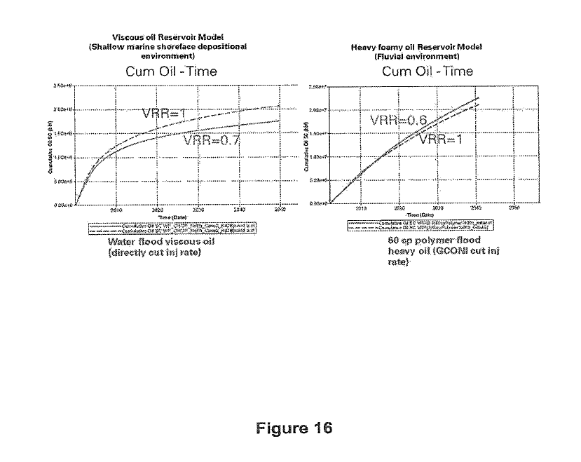

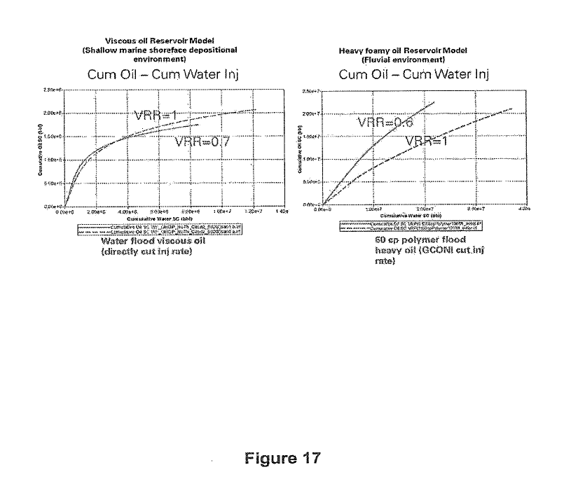

Differences in VRR<1.0 performance are shown in FIGS. 16 and 17. In particular, FIG. 16 shows the Cumulative Oil versus Time curves for VRR=1 and VRR<1.0 processes, and FIG. 17 shows the actual Cumulative Oil versus Cumulative Water Injected (equivalent to Pore Volume Injected, PVI) curves for VRR=1 and VRR<1.0 processes. The heavy oil model displayed improved oil recovery on both time and PVI bases. The incremental oil recovery on PVI basis was significant. The viscous oil model displayed no improved recovery on a time basis and only slight improvement in the first 10 years of production on the PVI basis. Overall, the two models showed different response to the implementation of VRR<1 process.

Potential explanations of the difference in the VRR<1.0 process incremental recovery between the two models include the following factors: (1) Heterogeneity: the heavy oil model included more cul-de-sac type permeability features concomitant with its fluvial depositional environment; (2) Foamy oil effect: the heavy oil models had stronger solution gas drive, with lower krg and high Sgc; and (3) Three phase relative permeability effects: the heavy oil model had potentially stronger three phase relative permeability interference effects with higher Sgc value.

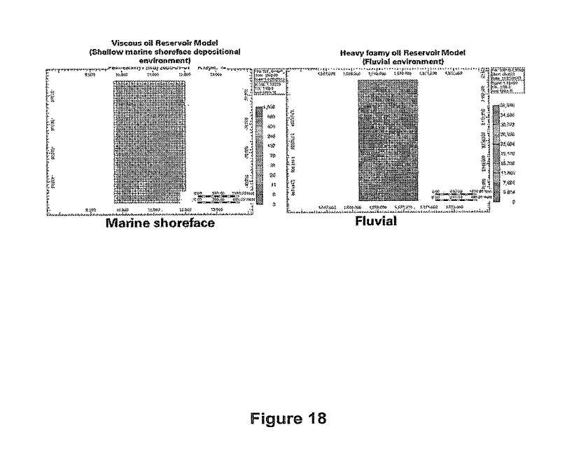

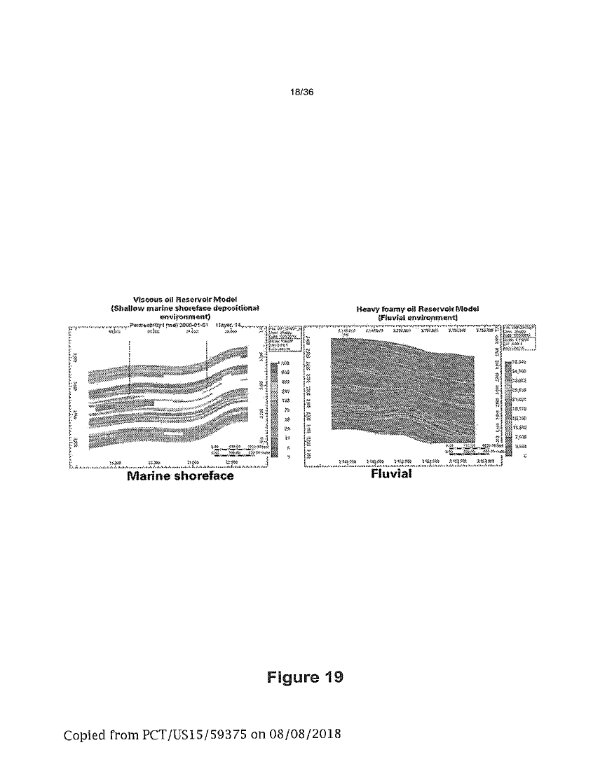

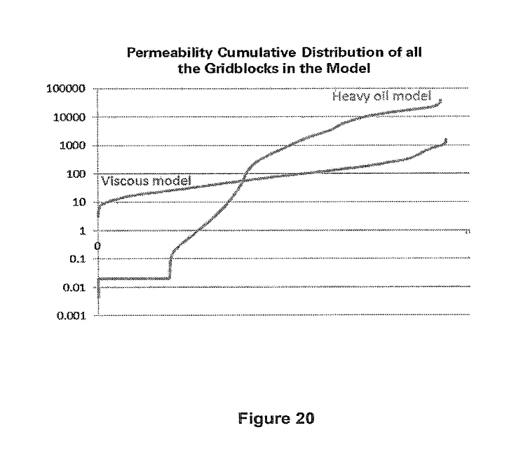

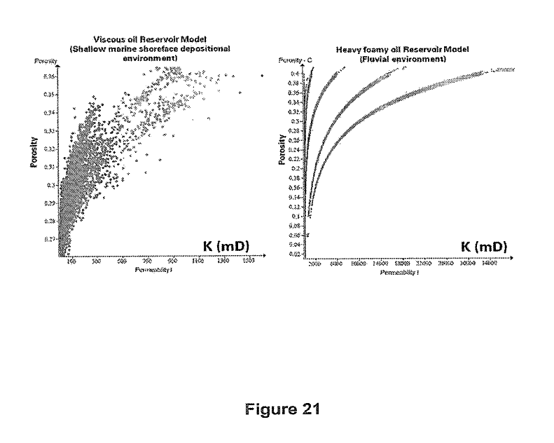

Next, these differences were examined in more detail, beginning with heterogeneity—the viscous model's depositional environment was shallow marine, with a permeability variation of 3-4 orders of magnitude; and the heavy oil model's depositional environment was fluvial, with a greater permeability variation of 6 orders of magnitude. FIG. 18 illustrates the heterogeneity comparison between viscous oil TPM and heavy oil TPM in the horizontal plane, and FIG. 19 illustrates the heterogeneity comparison between viscous oil TPM and heavy oil TPM in the vertical plane. FIG. 20 illustrates the permeability cumulative distribution of all the gridblocks in the two TPM models, and FIG. 21 illustrates the porosity versus permeability of all the gridblocks in the viscous oil and heavy oil TPM models (larger heterogeneity variation in the heavy oil model, with 4 different facies).

For the gas-liquid relative permeability, the heavy oil model had a critical gas saturation (Sgc) of about 8% and it had very low krg values at small Sg values, simulating the foamy oil drive. The critical gas saturation (Sgc) in the viscous oil model was very small, 1.5%.

With the higher Sgc value, the heavy oil model was expected to exhibit stronger three phase relative permeability interference effects. As the gas saturation is increased, the kro increases initially, and then decreases. This leads to the water fractional flow fw=(1/(1+(kro/krw*μw/μo)) that initially decreases and later increases. If implemented properly, it will lead to a decrease in water cut and improved oil recovery.

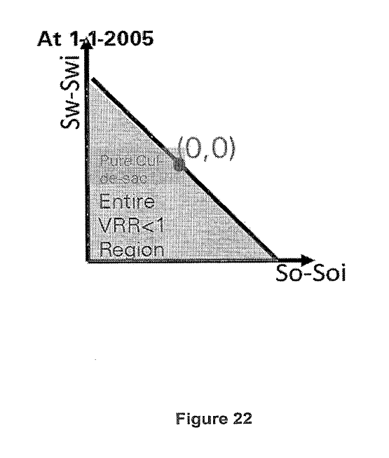

Finally, the VRR<l/cul-de-sac effects were visualized and quantified in these two simulation models. First, the methodology shown in FIG. 22 was employed to identify and quantify all the VRR<1.0 grid blocks in the simulation model. For cells with only pure water displacement and without gas presence, (Sw-Swi)=-−×(So-Soi). For cells with VRR<1 (all of the VRR<1 mechanisms, except emulsion), the presence of gas leads to −1×(So-Soi)>(Sw-Swi) (i.e., more oil is displaced than water saturation change in that cell). The summation of (−1×(So-Soi)−(Sw-Swi)) for all the entire VRR<1.0 cells is the total VRR<1.0 improved recovery oil amount. The pure Cul-de-sac effect region was defined to be the subset of the entire VRR<1 cells region that has circa zero water saturation change, identifying the cells not swept by water. Account needs to be taken of numerical diffusion causing the presence of water in grid blocks unswept by water. Thus, the unswept cul-de-sac regions are larger and more pervasive than those identified merely by a zero water saturation increase (above connate). Consequently, the unswept regions are identified by a band rather than a line in FIG. 22.

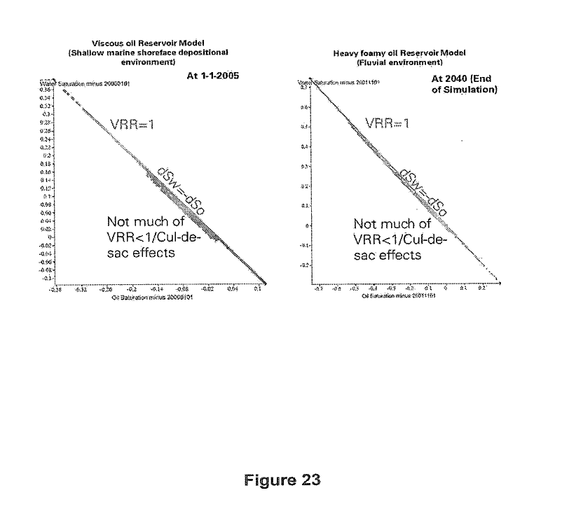

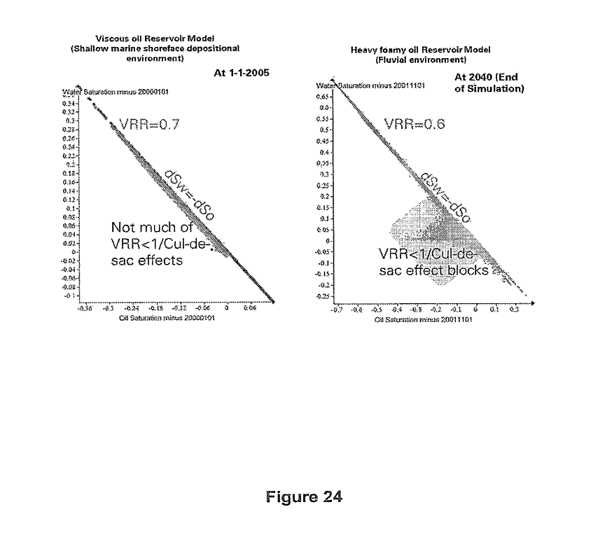

FIG. 23 is the VRR<1/Cul-de-sac effects plot for the VRR=1 process in the viscous and heavy TPMs. For VRR=1, cells in the VRR<1/Cul-de-sac zone were rarely seen. FIG. 24 is the VRR<1/cul-de-sac effects plot for the VRR<1 process in the viscous and heavy oil TPMs. In FIG. 24, the minimal effects of VRR<1/cul-de-sac for the viscous oil model are seen. For the heavy oil model, the large number of grid blocks in the VRR<1/cul-de-sac zone were observed. This illustrates why there was a much higher incremental recovery for VRR=0.6 in the heavy oil model.

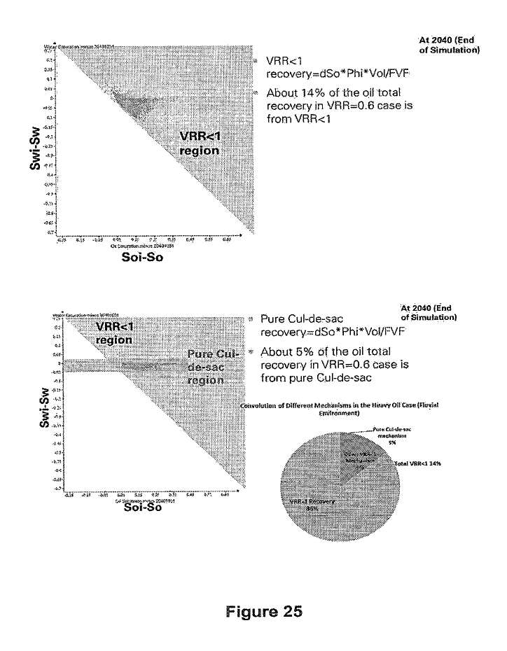

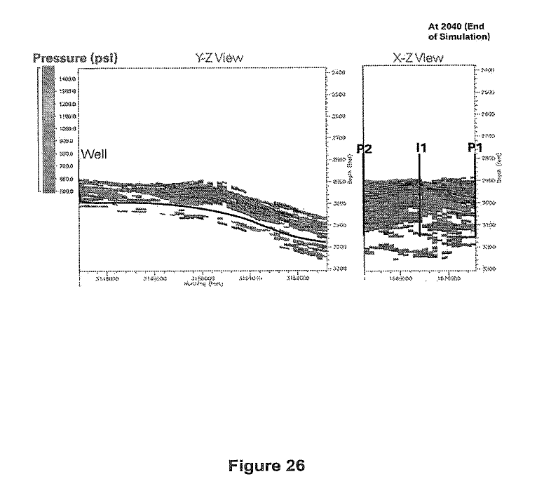

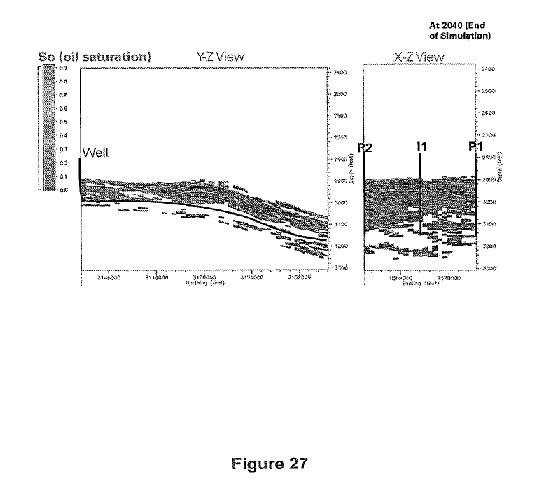

The pure Cul-de-sac effect region and oil recovery amount were calculated in FIG. 25. It was estimated that of the total oil recovery from this model, about 5% comes from the pure Cul-de-sac effect. The remaining 9% came from solution gas drive and three phase relative permeability effects in the water swept region. FIGS. 26 and 27 illustrate the 3D view of the pure Cul-de-sac cells in the heavy oil model (pressure and oil saturation profile). The Cul-de-sac cells are mostly cells above the horizontal layer where the injector well and producer well reside, and the cells around the producer.

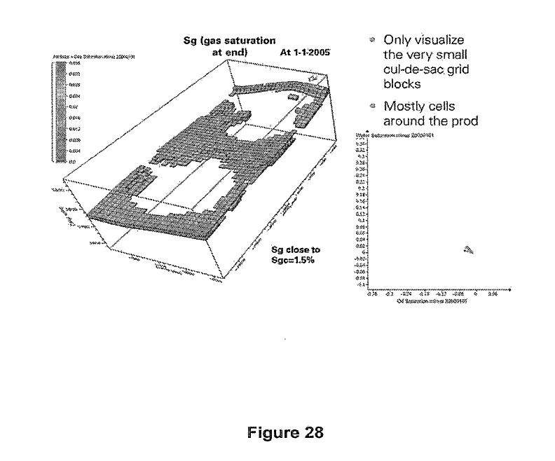

The viscous oil model's cul-de-sac regions were also visualized. FIG. 28 illustrates the gas saturation Sg in the small cul-de-sac zone in the viscous oil model. The low pressure areas around the producer well indicates that solution gas drives small amount of oil towards the producer well (Sg˜Sgc=1.5%). From the comparison between heavy oil model and viscous oil model, it can be seen that solution gas drive is one of the key factors in the impact of the cul-de-sac mechanism.

### EXAMPLE 3

### Heavy Oil Waterflood Emulsion and Its Modelling

The conventional conceptualization of oil and water flow is that the phases slip past each other as described mathematically by the Buckley-Leverett (B-L) theory. However, in some heavy oil reservoirs, empirical evidence suggests the phases flow by embedding themselves within each other and form emulsions. Under some conditions, emulsion flow may contribute to the improved oil recovery in the VRR<1.0 process.

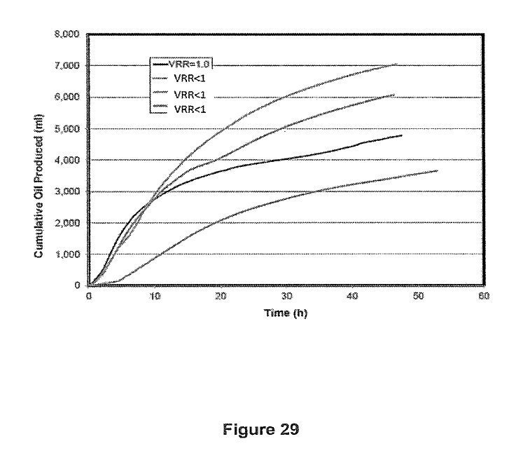

To verify and better understand the emulsion flow physics in heavy oil water flooding, a series of experiments were performed at AITF (Edmonton, Canada). FIG. 29 illustrates the cumulative oil production versus time curve for a 12 API Alaska heavy oil, with an in-situ viscosity of circa 2,000 cp, of a “big can” VRR<1.0 experiment. Improved oil recovery for the two cases with VRR<1.0 was observed. Microscopic images taken at atmospheric pressure of the produced fluid during the VRR=1 test for the heavy oil water flood experiment shown in FIG. 29 revealed micron-sized water droplets dispersed in the aqueous phase, which constituted the water-in-oil emulsion. The water droplets were small enough to move through a typical pore throat in unconsolidated sand heavy oil reservoirs. This indicated that the emulsion flow was analogous to a single phase flow similar as generating quasi-miscibility of water and oil in the reservoir under dynamic flow conditions.

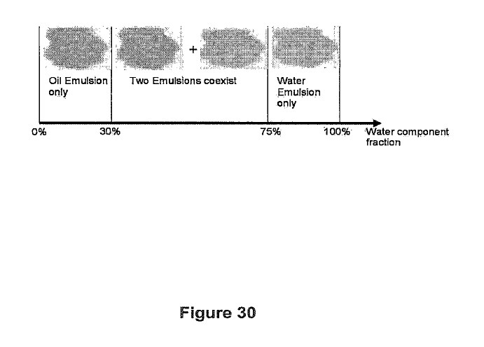

Based on the foregoing, a simplified model for modeling heavy oil in-situ emulsion flow was developed as follows. Assuming that for certain levels of shear and chemical conditions, the water component can be dispersed as small droplets into the oleic phase to form an oil emulsion and the same for oil dispersed into an aqueous phase. Furthermore, the dispersed water droplets move at the same speed as the oleic phase, and the same for oil dispersed in the aqueous phase. Considering a specific block, and starting from 100% pure oil and gradually add water into it. Up to a certain fraction limit, all the water can be dispersed into the oleic phase, maintaining a single phase. Then, above a certain fraction, forming another free aqueous phase will begin, which also has some oil in it. By continuing to add water, eventually the oleic phase will disappear, with single aqueous phase left in the block. The water can continue to be added, reducing oil until at the end there is 100% pure water. FIG. 30 illustrates one possible sequence of phase behavior of emulsion formation and flow in a block of the simulation model—a maximum of 30% water can be dispersed in the oil, the formation of two emulsions at a water content between 30 and 75% water, and the existence of only the aqueous emulsion for higher water fractions. These two fraction limits are a function of shear and oil chemistry, which could be calibrated from experiments. For the Buckley-Leverett flow, on the other hand, it is assumed water and oil are completely immiscible (i.e., the water component stays only in the aqueous liquid phase and the oil component only in the oleic phase).

For simplicity, a 1D analytical formulation of emulsion flow was developed, and is presented below. There are two phases, aqueous and oleic phase (water emulsion phase and oil emulsion phase). Water and oil components can exist in both liquid phases within a certain ratio. The two phase saturations are S₁ and S₂. The fractional flow functions for aqueous and oleic phases are f₁ and f₂. Assuming incompressibility, plus aqueous and oleic phase viscosities constant, the transport equations of water and oil components are as follows:

$$\frac{\partial {C}_{w}}{\partial t} + \frac{\partial {F}_{w}}{\partial X} = 0$$

$$\frac{\partial {C}_{o}}{\partial t} + \frac{\partial {F}_{o}}{\partial x} = 0$$

Here, the water and oil component concentrations are as follows:

C_{w}=S₁x_{w}+S₂y_{w}

Cₒ=S₁xₒ+S₂yₒ

The fluxes for water and oil components are as follows:

Fₒ=f₁xₒ+f₂yₒ

F_{w}=f₁x_{w}+f₂y_{w}

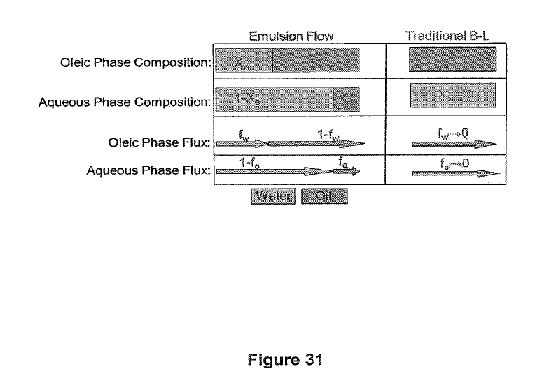

A modified black oil model was developed to model the emulsion flow for future field simulations. In actual field simulation, the time scale of the flow transport will be much larger than the emulsion formation and decomposition process. Therefore, it is reasonable to neglect the kinetic transient process and assume equilibrium is reached instantaneously. Here, the emulsion phase behavior as described previously was used. FIG. 31 illustrates the mechanism of the proposed modified black oil model for heavy oil water flooding. The three conservation equations for the water, oil and gas components are as follows:

$$\frac{\partial }{\partial t} ( φ {b}_{o} {S}_{o} ( 1 - {X}_{w} ) + φ {b}_{o} {S}_{w} {X}_{o} ) = ∇ \cdot ( {b}_{o} ( 1 - {f}_{w} ) {u}_{o} ) + ∇ \cdot ( {b}_{o} {f}_{o} {u}_{w} ) - {b}_{o} {q}_{o}^{w}$$

$$\frac{\partial }{\partial t} ( φ {b}_{w} {S}_{w} ( 1 - {X}_{o} ) + φ {b}_{w} {S}_{o} {X}_{w} ) = ∇ \cdot ( {b}_{w} ( 1 - {f}_{o} ) {u}_{w} ) + ∇ \cdot ( {b}_{w} {f}_{w} {u}_{o} ) - {b}_{w} {q}_{w}^{w}$$

$$\frac{\partial }{\partial t} ( φ {b}_{g} {S}_{g} + φ {R}_{s} {b}_{o} ( {S}_{o} ( 1 - {X}_{w} ) + {S}_{w} {X}_{o} ) ) = ∇ \cdot ( {R}_{s} {b}_{o} ( 1 - {f}_{w} ) {u}_{o} ) + ∇ \cdot ( {R}_{s} {b}_{o} {f}_{o} {u}_{w} ) + ∇ \cdot ( {b}_{g} {u}_{g} ) - {R}_{s} {b}_{o} {q}_{o}^{w} - {b}_{g} {q}_{g}^{w}$$

In this new formulation, the oil component does not only stay in oleic phase, and the same for water component. The solution gas behavior is still described by the Rₛ function (solution gas/oil ratio function). When calculating phase velocity, the viscosity changes are considered due to phase emulsification. The fraction X_{w}, Xₒ, f_{w} and fₒ functions are key to the success of the simulations. All the emulsification effects have been packaged into these functions. They will depend on local conditions in the grid block, for example: the local shear rate, the solution gas effect, the oil chemistry, the concentration of particulates and concentration of surfactant.

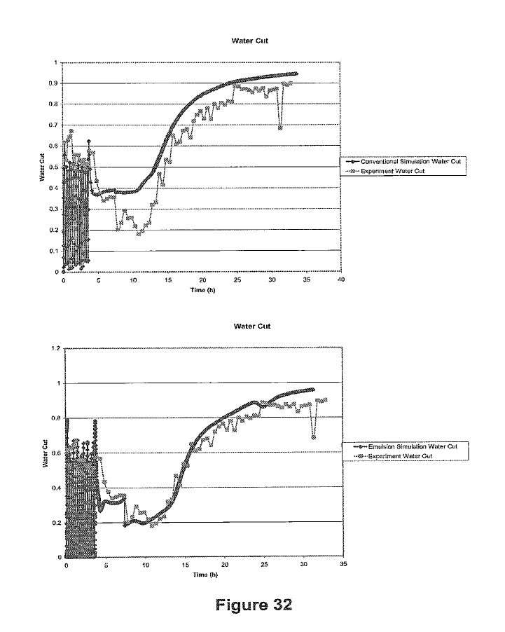

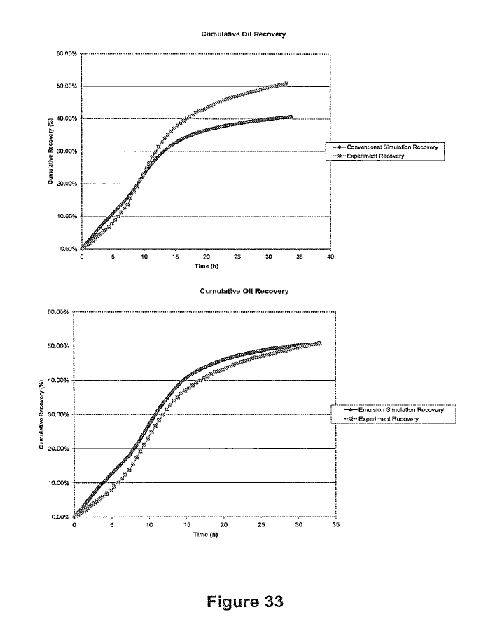

One example of improved history match through the use of modified black oil formulation which considered emulsion formation is shown in FIG. 32. This was the example of the history match of one of the “big can” experiment conducted for a viscous oil. FIG. 32 illustrates the improved water cut match using the proposed emulsion flow modified black oil model for viscous oil water flooding big can experiment. It was assumed stronger oil emulsion formed with larger water content, from the start of VRR=0.7 in the experiment at 7 hours. The water cut match was improved. The chemical reaction model in CMG STARS was used to model the water and oil emulsion phase behavior in this history match. FIG. 33 illustrates the improved cumulative oil recovery match using the proposed emulsion flow modified black oil model for viscous oil water flooding “big can” experiment.

### EXAMPLE 4

### Heavy Oil Waterflood Emulsion and Its Modelling

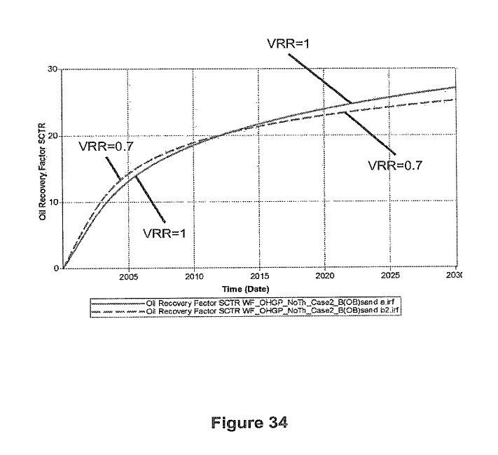

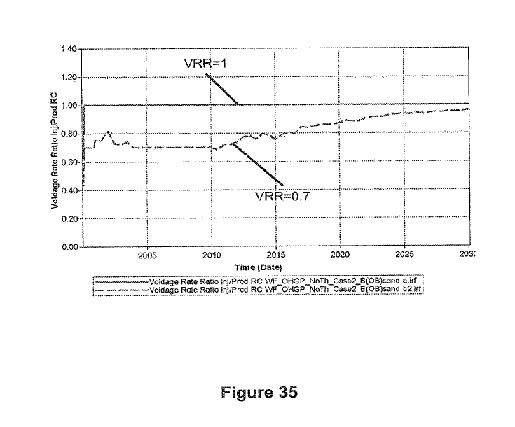

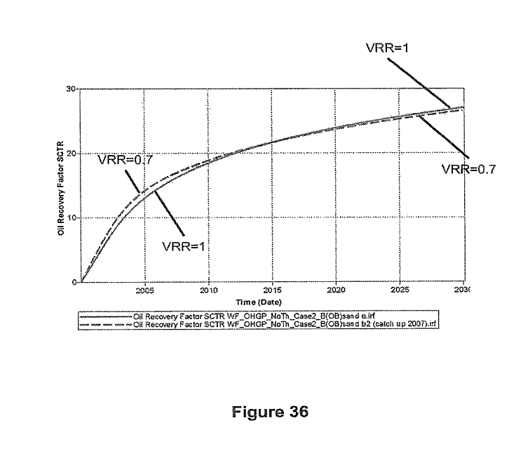

Numerical simulations that suggested improvements to the VRR<1.0 process by conducting time evolution optimizations were conducted using the same example test case for the viscous oil waterflood previously described in Example 2 above. The VRR<1.0 process was implemented by increasing the total production rate in the producer wells. FIG. 34 illustrates the test results for oil recovery factor (RF) versus time for the viscous oil VRR<1.0 process and the VRR=1 process. In the VRR<1.0 process, the VRR was maintained at 0.7 for the entire life of the reservoir, and in the VRR=1 process, the VRR was maintained at 1.0 for the entire life of the reservoir. As shown in FIG. 34, the simulation indicated that oil recovery at VRR<1.0 improved in the first 10 years, however, afterwards, the oil recovery at VRR<1.0 become less effective. FIG. 35 illustrates the actual VRR versus time for the viscous oil VRR<1.0 process, which was run for the entire reservoir life, though it was not fully supported in the time after 2015 due to the producer wells reaching BHP pressure limits. As shown in FIG. 34, even though an initial benefit was achieved, the final recovery was lower with VRR=0.7. It is believed this was due to the loss of solution gas during the entire duration of the process, thereby making the oil in place more viscous. The increase in viscosity changes the oil/water fractional flow curve and makes the final oil recovery lower. Accordingly, one solution to this scenario is to shorten the duration of VRR<1.0 process (i.e. catch up with VRR=1 after certain number of years of VRR<1.0). FIG. 36 illustrates the oil recovery versus time when VRR=0.7 was implemented only for the first 7 years of the process followed by VRR=1. As is shown in FIG. 36, improved oil recovery was observed in the first 10 years, and thereafter, not much difference in oil recovery was observed. In this case, VRR<1.0 process successfully accelerated the oil recovery in the first 10 years, which may increase the commercial project's net present value NPV. This relatively simple example illustrates the impact of time evolution optimization of the VRR<1.0 process.

What is claimed is:

1. A method for waterflooding of a reservoir in a subterranean formation to produce oil from the reservoir, the method comprising:
(a) appraising the reservoir to obtain a plurality of physical properties relating to the formation and the oil in the reservoir, wherein the plurality of physical properties include a reservoir pressure and a Bubblepoint pressure of the oil in the reservoir;
(b) determining that the Bubblepoint pressure is greater than 60% of the reservoir pressure;
(c) based on the determination in (b), waterflooding the reservoir at a voidage replacement ratio (VRR) less than 1.0.

2. The method of claim 1, wherein (b) further comprises at least two of the following:
(b1) determining that the oil in the reservoir has an American Petroleum Institute (API) gravity less than 27.0;
(b2) determining that the oil in the reservoir has a total acid number (TAN) greater than 1.0 mg KOH per gram of the oil;
(b3) determining that the reservoir exhibits a permeability cumulative distribution including at least three cycles in the log scale;
(b4) determining that the reservoir has a maximum true stratigraphic thickness (TST) greater than 50 ft.;
(b5) determining that the reservoir exhibits a first water fractional flow at a first gas saturation (Sg) of 0.15 that is equal to or less than a second water fractional flow at a second gas saturation (Sg) of 0.0; and
(b6) determining that the reservoir exhibits a critical gas saturation (Sgc) greater than 0.04.

3. The method of claim 1, wherein (a) further comprises:
(a1) determining an American Petroleum Institute (API) gravity of the oil in the reservoir;
(a2) determining a total acid number (TAN) of the oil in the reservoir;
(a3) determining a maximum true stratigraphic thickness (TST) of the reservoir; and
(a4) determining a critical gas saturation (Sgc) of the reservoir;
wherein (b) further comprises at least two of the following:
(b1) determining that the API gravity of the oil is less than 22.0;
(b2) determining that the TAN of the oil is greater than 1.0 mg KOH per gram;
(b3) determining that the reservoir exhibits a permeability cumulative distribution including at least four cycles in the log scale;
(b4) determining that the maximum true stratigraphic thickness (TST) of the reservoir is greater than 50 ft.;
(b5) determining that the reservoir exhibits a first water fractional flow at a first gas saturation (Sg) of 0.15 that is equal to or less than a second water fractional flow at a second gas saturation (Sg) of 0.0;
(b6) determining that the critical gas saturation (Sgc) of the reservoir is greater than 0.04.

4. The method of claim 3, further comprising determining a location for an injection well, a location for a production well, and a spacing between the injection well and the production well;
wherein (b) further comprises determining that the spacing between the injection well and the production well is at least 1,300 ft.

5. The method of claim 2, wherein waterflooding the reservoir comprises:
injecting water into the reservoir with an injection well; and
producing at least some of the oil in the reservoir with a production well;
wherein the injection well and the production well are spaced apart at least 1,300 ft.

6. The method of claim 2, further comprising:
determining a solution gas oil ratio (GOR) of the oil in the reservoir in (a);
injecting water into the reservoir with an injection well;
producing at least some of the oil in the reservoir with a production well;
monitoring a production gas oil ratio of the oil produced with the production well;
determining that the production GOR is at least 30% greater than the solution GOR; and
based on the determination that the production GOR is at least 30% greater than the solution GOR, increasing the VRR to 1.0.

7. The method of claim 2, further comprising:
continuing the waterflood of the reservoir at the VRR less than 1.0 for a period of time; and
increasing the VRR to 1.0 after the period of time.

8. The method of claim 1, further comprising defining a period of time to maintain the waterflood at the VRR less than 1.0 before (c).

9. The method of claim 2, further comprising:
modeling the reservoir using the physical properties obtained in (a);
based on (b) and before (c), using the model to simulate a waterflood of the reservoir at a first VRR less than 1.0 for a first period of time;
based on the simulation of the waterflood at the VRR less than 1.0, selecting a second VRR less than 1.0 that is different than the first VRR less than 1.0 and selecting a second period of time that is different than the first period of time;
using the model to simulate a waterflood of the reservoir at the second VRR less than 1.0 for the second period of time.

10. A method for waterflooding of a reservoir in a subterranean formation to produce oil from the reservoir, the method comprising:
(a) appraising the reservoir to obtain a plurality of physical properties relating to the formation and the oil in the reservoir;
(b) modeling the reservoir based on the physical properties obtained in (a);
(c) performing a first waterflood simulation of the reservoir in the model at a first voidage replacement ratio (VRR) equal to 1.0;
(d) performing a second waterflood simulation of the reservoir in the model at a second voidage replacement ratio (VRR) less than 1.0;
(e) determining at least one of the following:
that the second waterflood simulation yields a greater cumulative oil recovery from the reservoir than the first waterflood simulation over a period of time; and
that the second waterflood simulation yields a greater recovery factor (RF) than the first waterflood simulation over a range of pore volumes injected;
(f) based on the determination in (e), waterflooding the reservoir at a voidage replacement ratio (VRR) less than 1.0.

11. The method of claim 10, further comprising determining that a Bubblepoint pressure of the oil in the reservoir obtained in (a) is greater than 60% of a reservoir pressure obtained in (a) before (d).

12. The method of claim 11, further comprising at least two of the following:
determining that the oil in the reservoir has an American Petroleum Institute (API) gravity less than 27.0;
determining that the oil in the reservoir has a total acid number (TAN) greater than 1.0 mg KOH per gram of the oil;
determining that the reservoir exhibits a permeability cumulative distribution including at least three cycles in the log scale;
determining that the reservoir has a maximum true stratigraphic thickness (TST) greater than 50 ft.;
determining that the reservoir exhibits a first water fractional flow at a first gas saturation (Sg) of 0.15 that is equal to or less than a second water fractional flow at a second gas saturation (Sg) of 0.0; and
determining that the reservoir exhibits a critical gas saturation (Sgc) greater than 0.04.

13. The method of claim 11, further comprising:
determining a location for an injection well, a location for a production well, and a spacing between the injection well and the production well;
determining that the spacing between the injection well and the production well is at least 1,300 ft. before (d).

14. The method of claim 11, further comprising:
(g) during (f), determining that a production GOR of the oil produced in a production well is at least 30% greater than a solution GOR of the oil in the reservoir obtained in (a); and
(h) based on (g), increasing the VRR to 1.0.

15. The method of claim 11, further comprising:
continuing the waterflood of the reservoir at the VRR less than 1.0 for a period of time; and
increasing the VRR to 1.0 after the period of time.

16. The method of claim 11, further comprising:
determining a minimum well spacing between an injection well and a production well before (c);
determining a water injection rate before (c); and
based on (d), changing the minimum well spacing or the water injection rate.

17. A method for waterflooding of a reservoir in a subterranean formation to produce oil from the reservoir, the method comprising:
(a) waterflooding the reservoir with an injection well and a production well;
(b) operating the waterflood at a first voidage replacement ratio (VRR) less than 1.0 for a first period of time; and
(c) operating the water flood at a second VRR equal to 1.0 after the first period of time.

18. The method of claim 17, further comprising:
determining a solution gas oil ratio (GOR) of the oil in the reservoir;
monitoring a production gas oil ratio of the oil produced with the production well;
determining that the production GOR is at least 30% greater than the solution GOR; and
transitioning the operation of the waterflood from the first VRR less than 1.0 to the second VRR equal to 1.0 in response to the determination that the production GOR is at least 30% greater than the solution GOR.

19. The method of claim 17, wherein the oil in the reservoir has an American Petroleum Institute (API) gravity less than 22.0.

20. The method of claim 19, wherein the subterranean formation exhibits a volumetric sweep efficiency less than 50%.

21. The method of claim 17, wherein the injection well and the production well are spaced apart a distance that is at least 1,300 ft.
